(19) United States
(12) Patent Application Publication
(10) Pub. No.: US 2026/0025451 A1
(43) Pub. Date: Jan. 22, 2026

(54) CONNECTOR AND ELECTRONIC DEVICE INCLUDING THE SAME

(71) Applicant: SAMSUNG ELECTRONICS CO., LTD., Suwon-si (KR)

(72) Inventors: Seulki OH, Suwon-si (KR); Namki KIM, Suwon-si (KR); Yongseok PARK, Suwon-si (KR); Cheongno YUN, Suwon-si (KR); Bonggi CHO, Suwon-si (KR)

(21) Appl. No.: 19/219,181

(22) Filed: May 27, 2025

Related U.S. Application Data
(63) Continuation of application No. PCT/KR2025/005152, filed on Apr. 15, 2025.

(30) Foreign Application Priority Data
Jul. 19, 2024 (KR) 10-2024-0095997
Sep. 2, 2024 (KR) 10-2024-0118672

(51) Int. Cl. H04M 1/02; H01R 12/72

(52) U.S. Cl. CPC H04M 1/0277; H01R 12/722

(57) ABSTRACT

An electronic device includes: a printed circuit board, a contact located around the printed circuit board, and a connector, disposed on the printed circuit board, and configured to electrically connect the contact and the printed circuit board. The connector includes a leg portion in contact with the printed circuit board and a cover portion extending from the leg portion and in contact with the contact. An inner surface of the cover portion facing a direction of the contact has a step shape including a first flat surface and a second flat surface parallel to the first flat surface and positioned at a different height from the first flat surface. The contact is in contact with the first flat surface from among the first flat surface and the second flat surface of the inner surface of the cover portion.

### CROSS-REFERENCE TO RELATED APPLICATIONS

This application is a continuation of International Application No. PCT/KR2025/005152 designating the United States, filed on Apr. 15, 2025, in the Korean Intellectual Property Receiving Office and claiming priority to Korean Patent Application Nos. 10-2024-0095997, filed on Jul. 19, 2024, and 10-2024-0118672, filed on Sep. 2, 2024, in the Korean Intellectual Property Office, the disclosures of each of which are incorporated by reference herein in their entireties.

### BACKGROUND

### Field

The disclosure relates to a connector and an electronic device including the same.

### Description of Related Art

An electronic device such as a smartphone may include a connector mounted on a printed circuit board. By contacting a spring contact such as, for example, a C-clip, the connector may electrically connect the spring contact and the printed circuit board.

The above-described information may be provided as a related art for the purpose of helping understanding of the present disclosure. No assertion or decision is made as to whether any of the above description may be applied as a prior art related to the present disclosure.

### SUMMARY

According to an example embodiment, an electronic device may comprise: a printed circuit board, a contact located around the printed circuit board, and a connector, disposed on the printed circuit board, and configured to electrically connect the contact and the printed circuit board. The connector may include: a leg portion in contact with the printed circuit board, and a cover portion extending from the leg portion and in contact with the contact. An inner surface of the cover portion facing a direction of the contact may have a step shape including a first flat surface, and a second flat surface parallel to the first flat surface and positioned at a different height from the first flat surface. The contact may be in contact with the first flat surface from among the first flat surface and the second flat surface of the inner surface of the cover portion.

According to an example embodiment, an electronic device may comprise: a printed circuit board, a contact located around the printed circuit board, and a connector, disposed on the printed circuit board, and configured to electrically connect the contact and the printed circuit board. The connector may include a cover portion spaced apart from the printed circuit board and in contact with the contact, and a stepped leg portion extending from the cover portion and coupled to the printed circuit board. The stepped leg portion of the connector may include a first flat surface, facing a direction of the printed circuit board, and parallel to a surface of the printed circuit board, and a second flat surface, facing the direction of the printed circuit board, parallel to the first flat surface, and positioned at a different height from the first flat surface. The surface of the printed circuit board may be configured to support the connector by contacting the first flat surface from among the first flat surface and the second flat surface of the stepped leg portion.

According to an example embodiment, a connector mounted on a printed circuit board may comprise: a leg portion configured to be at least partially inserted into the printed circuit board, and a cover portion extending from the leg portion. An inner side of the cover portion may be configured to be in contact with a contact. The inner side of the cover portion may include a step shape such that the connector provides a different height of an area of the cover portion with which the contact is in contact according to a position at which the connector is coupled to the printed circuit board.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2A is a diagram illustrating an example electronic device according to various embodiments;

FIG. 2B is an exploded perspective view of an example electronic device according to various embodiments;

FIGS. 3A and 3B include a perspective view and a cross-sectional view illustrating a connector of an electronic device according to various embodiments;

FIGS. 4A and 4B are diagrams illustrating a connector connected to a printed circuit board and an electronic component according to various embodiments;

FIGS. 5A and 5B include a perspective view and a cross-sectional view illustrating a connector according to various embodiments;

FIG. 6 is a perspective view illustrating a connector according to various embodiments;

FIGS. 7A and 7B are perspective views illustrating a connector according to various embodiments;

FIG. 7C is a diagram illustrating a leg portion of a connector according to various embodiments;

FIGS. 8A and 8B are cross-sectional views illustrating a connector connected to a printed circuit board and an electronic component according to various embodiments;

FIGS. 9A and 9B are perspective views illustrating a connector according to various embodiments;

FIGS. 9C and 9D include a perspective view and a diagram illustrating a leg portion of a connector according to various embodiments;

FIGS. 10A, 10B, 10C, and 10D include perspective views and cross-sectional views illustrating a connector connected to a printed circuit board and an electronic component according to various embodiments;

FIGS. 11A, 11B, and 11C are perspective views illustrating a connector according to various embodiments;

FIG. 12A is a diagram illustrating a connector according to various embodiments;

FIGS. 12B, 12C, 12D, and 12E are diagrams illustrating a printed circuit board and a connector coupled in different positions according to various embodiments; and

FIGS. 13A and 13B are perspective views illustrating a connector according to various embodiments.

### DETAILED DESCRIPTION

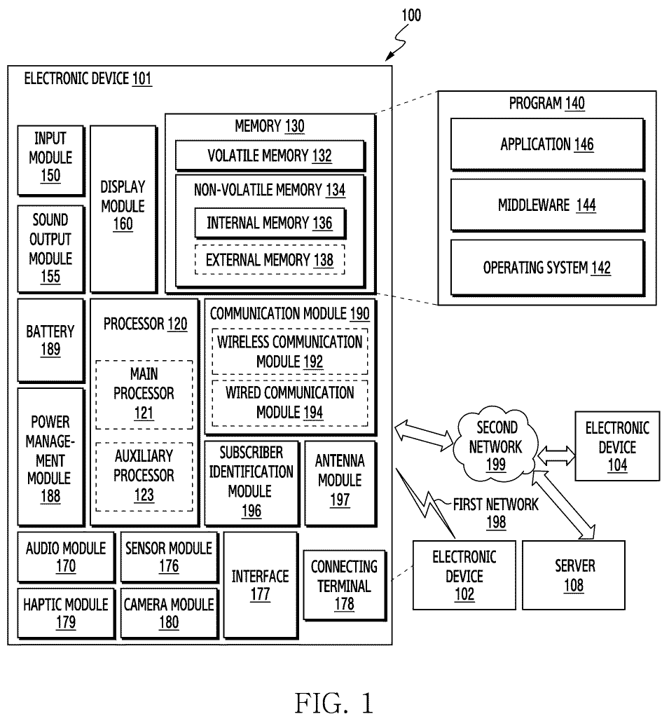

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a kcy (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing cMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

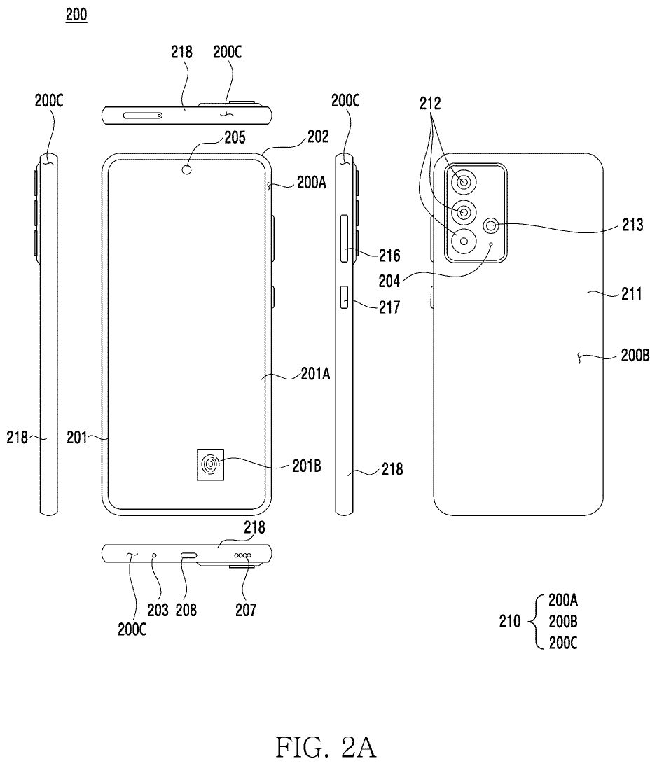

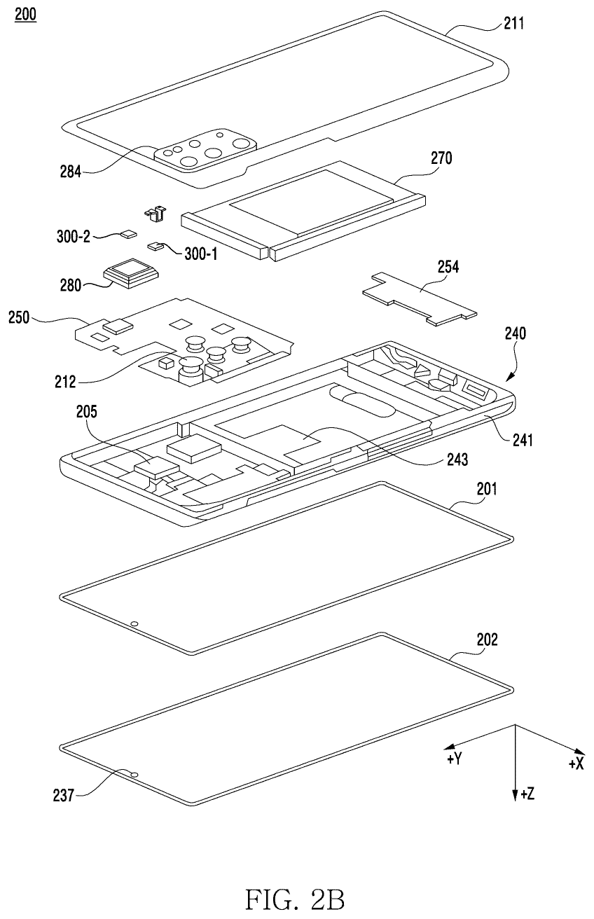

FIG. 2A is a diagram illustrating an example electronic device according to various embodiments. Referring to FIG. 2A, an electronic device 200 according to an embodiment may include a housing 210 that at least partially forms an exterior of the electronic device 200. For example, the housing 210 may include a first surface (or a front surface) 200A, a second surface (or a rear surface) 200B, and a third surface (or a lateral surface) 200C surrounding a space between the first surface 200A and the second surface 200B. In an embodiment, the housing 210 may refer to a structure forming at least a portion of the first surface 200A, the second surface 200B, and/or the third surface 200C.

The electronic device 200 according to an embodiment may include a substantially transparent front plate 202. In an embodiment, the front plate 202 may form at least a portion of the first surface 200A. In an embodiment, the front plate 202 may include, for example, a glass plate or a polymer plate including various coating layers, but is not limited thereto.

The electronic device 200 according to an embodiment may include a substantially opaque rear plate 211. In an embodiment, the rear plate 211 may form at least a portion of the second surface 200B. In an embodiment, the rear plate 211 may be formed of coated or colored glass, ceramic, polymer, metal (e.g., aluminum, stainless steel, or magnesium), or a combination of at least two of the materials.

The electronic device 200 according to an embodiment may include a lateral bezel structure (e.g., a lateral member or a bracket) 218. In an embodiment, the lateral bezel structure 218 may form at least a portion of the third surface 200C of the electronic device 200 by being coupled with the front plate 202 and/or the rear plate 211. For example, the lateral bezel structure 218 may form the entire third surface 200C of the electronic device 200, and for another example, the lateral bezel structure 218 may form the third surface 200C of the electronic device 200 together with the front plate 202 and/or the rear plate 211.

Unlike an illustrated example, in case that the third surface 200C of the electronic device 200 is partially formed by the front plate 202 and/or the rear plate 211, the front plate 202 and/or the rear plate 211 may include a portion extending from its edge, bent toward the rear plate 211 and/or the front plate 202. The extending portion of the front plate 202 and/or the rear plate 211 may be located at both ends of a long edge of the electronic device 200, but is not limited by the above-described example.

In an embodiment, the lateral bezel structure 218 may include metal and/or polymer. In an embodiment, the rear plate 211 and the lateral bezel structure 218 may be integrally formed and may include the same material (e.g., a metallic material such as aluminum), but are not limited thereto. For example, the rear plate 211 and the lateral bezel structure 218 may be formed in a separate configuration and/or may include different materials.

In an embodiment, the electronic device 200 may include a display 201 (e.g., the display module 160 of FIG. 1), an audio module 203, 204, or 207 (e.g., the audio module 170 of FIG. 1), a sensor module (e.g., the sensor module 176 of FIG. 1), a camera module 205, 212, or 213 (e.g., the camera module 180 of FIG. 1), a light emitting element (not illustrated), and a connector hole 208. In an embodiment, the electronic device 200 may omit at least one (e.g., the light emitting device (not illustrated)) of the components, or may additionally include another component.

In an embodiment, the display 201 may be visible through a significant portion of the front plate 202. For example, at least a portion of the display 201 may be visible through the front plate 202 forming the first surface 200A. The display 201 may be disposed on a back surface of the front plate 202.

In an embodiment, in order to expand an area in which the display 201 is visible, an outer periphery shape of the display 201 may be formed substantially the same as an outer periphery shape of the front plate 202 adjacent to the display 201. In an embodiment, a gap between an outer periphery of the display 201 and an outer periphery of the front plate 202 may be formed substantially the same.

In an embodiment, the display 201 (or the first surface 200A of the electronic device 200) may include a screen display area 201A. In an embodiment, the display 201 may provide visual information to a user through the screen display area 201A. In an illustrated embodiment, when the first surface 200A is viewed from a front, the screen display area 201A is spaced apart from an outer periphery of the first surface 200A and is located in an inner side of the first surface 200A, but is not limited thereto. For example, when the first surface 200A is viewed from the front, at least a portion of an edge of the screen display area 201A may substantially coincide with an edge of the first surface 200A (or the front plate 202).

In an embodiment, the screen display area 201A may include a sensing area 201B configured to obtain biometric information of the user. Herein, a meaning of “the screen display area 201A includes the sensing area 201B” may be understood as that at least a portion of the sensing area 201B may be overlapped with the screen display area 201A. For example, the sensing area 201B may refer, for example, to an area in which the visual information may be displayed by the display 201 like another area of the screen display area 201A, and additionally obtain the biometric information (e.g., fingerprint) of the user. Although the sensing area 201B is illustrated as being formed in the screen display area 201A, but is not limited thereto. For example, the sensing area 201B may be formed in key buttons 216 and/or 217.

In an embodiment, the display 201 may include an area in which the first camera module 205 is located. For example, an opening may be formed in the area of the display 201, and the first camera module 205 (e.g., a punch hole camera) may be at least partially disposed in the opening to face the first surface 200A. In this case, the screen display area 201A may surround at least a portion of an edge of the opening. In an embodiment, the first camera module 205 (e.g., an under display camera (UDC)) may be disposed under the display 201 to overlap the area of the display 201. In this case, the display 201 may provide visual information to the user through the area, and additionally, the first camera module 205 may obtain an image corresponding to a direction toward the first surface 200A through the area of the display 201.

In an embodiment, the display 201 may be coupled with or disposed adjacent to touch sensing circuitry, a pressure sensor capable of measuring intensity (pressure) of a touch, and/or a digitizer that detects a magnetic field type stylus pen.

In an embodiment, an audio module 203, 204, or 207 may include a microphone hole 203 or 204 and a speaker hole 207.

In an embodiment, the microphone hole 203 or 204 may include the first microphone hole 203 formed on a partial area of the third surface 200C and the second microphone hole 204 formed in a partial area of the second surface 200B. A microphone for obtaining an external sound may be disposed inside the microphone hole 203 or 204. The microphone may include a plurality of microphones to sense a direction of sound, but is not limited thereto.

In an embodiment, the second microphone hole 204 formed on the partial area of the second surface 200B may be disposed adjacent to the camera module 205, 212, or 213. For example, the second microphone hole 204 may obtain a sound according to an operation of the camera module 205, 212, or 213. However, the disclosure is not limited thereto.

In an embodiment, the speaker hole 207 may include the external speaker hole 207 and a call receiver hole (not illustrated). The external speaker hole 207 may be formed on a portion of the third surface 200C of the electronic device 200. In an embodiment, the external speaker hole 207 may be integrated into the microphone hole 203, and the speaker hole 207 and the microphone hole 203 may be implemented as one hole. Although not illustrated, the call receiver hole (not illustrated) may be formed on another portion of the third surface 200C. For example, the call receiver hole may be formed on an opposite side of the external speaker hole 207 in the third surface 200C. For example, based on an illustration of FIG. 2A, the external speaker hole 207 may be formed on the third surface 200C corresponding to a lower end of the electronic device 200, and the call receiver hole may be formed on the third surface 200C corresponding to an upper end of the electronic device 200. However, the disclosure is not limited thereto, and in an embodiment, the call receiver hole may be formed at a location other than the third surface 200C. For example, the call receiver hole may be formed by a space separated between the front plate 202 (or the display 201) and the lateral bezel structure 218.

In an embodiment, the electronic device 200 may include at least one speaker (not illustrated) (e.g., the sound output module 155 of FIG. 1 or an electronic component 280 of FIG. 2B) configured to output sound to the outside of the housing 210 through the external speaker hole 207 and/or the call receiver hole (not illustrated).

In an embodiment, a sensor module (not illustrated) may generate an electrical signal or a data value corresponding to an operating state of the inside or an environmental state of the outside of the electronic device 200. For example, the sensor module may include at least one of a proximity sensor, an HRM sensor, a fingerprint sensor, a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, or an illuminance sensor.

In an embodiment, the camera module 205, 212, or 213 may include the first camera module 205 disposed to face the first surface 200A of the electronic device 200, the second camera module 212 disposed to face the second surface 200B, and the flash 213.

In an embodiment, the second camera module 212 may include a plurality of cameras (e.g., a dual camera, a triple camera, or a quad camera). However, the second camera module 212 is not necessarily limited to including the plurality of cameras, and may include one camera.

In an embodiment, the first camera module 205 and the second camera module 212 may include one or a plurality of lenses, an image sensor, and/or an image signal processor.

In an embodiment, the flash 213 may include, for example, a light emitting diode or a xenon lamp. In an embodiment, two or more lenses (an infrared camera, wide-angle and telephoto lenses) and image sensors may be disposed on a surface of the electronic device 200.

In an embodiment, the electronic device 200 may include one or more key button assemblies (e.g., the input module 150 of FIG. 1). The one or more key button assemblies may include one or more key buttons disposed in the housing 210 to form a portion of the exterior of the electronic device 200. For example, the one or more key button assemblies may include key buttons 216 and/or 217 at least partially accommodated in a frame structure 240 to form a portion of the third surface 200C of the electronic device 200.

In an embodiment, the connector hole 208 may be formed on the third surface 200C of the electronic device 200 to accommodate a connector of an external device. A connecting terminal (e.g., the connecting terminal 178 of FIG. 1) electrically connected with the connector of the external device may be disposed in the connector hole 208. The electronic device 200 according to an embodiment may include an interface module (e.g., the interface 177 of FIG. 1) for processing an electrical signal transmitted and received through the connecting terminal.

According to an embodiment, the electronic device 200 may include a light emitting element (not illustrated). For example, the light emitting element (not illustrated) may be disposed on the first surface 200A of the housing 210. The light emitting element (not illustrated) may provide state information of the electronic device 200 in an optical form. In an embodiment, the light emitting element (not illustrated) may provide a light source linked with an operation of the first camera module 205. For example, the light emitting element (not illustrated) may include an LED, an IR LED, and/or a xenon lamp.

FIG. 2B is an exploded perspective view of an example electronic device according to various embodiments. Referring to FIG. 2B, an electronic device 200 according to an embodiment may include a frame structure 240 (e.g., the lateral bezel structure 218 of FIG. 2A), a first printed circuit board 250, a second printed circuit board 254, and a battery 270 (e.g., the battery 189 of FIG. 1).

In an embodiment, the frame structure 240 may be located between a display 201 and a rear plate 211. In an embodiment, the frame structure 240 may support or accommodate components included in the electronic device 200. For example, the display 201 may be disposed on a surface of the frame structure 240 facing in a direction (e.g., a +Z direction). The first printed circuit board 250, the second printed circuit board 254, the battery 270, and a second camera module 212 may be disposed on another surface of the frame structure 240 facing in another direction (e.g., a −Z direction) opposite to the direction. The first printed circuit board 250, the second printed circuit board 254, the battery 270, and the second camera module 212 may be disposed in a recess formed in the frame structure 240.

In an embodiment, the frame structure 240 may include a first part 241 and a second part 243. A peripheral portion of the second part 243 may be surrounded by the first part 241. The first part 241 may surround a space between the rear plate 211 and a front plate 202 (and/or the display 201). The first part 241 surrounding the space may at least partially form a lateral surface (e.g., the third surface 200C of FIG. 2A) of the electronic device 200, and the second part 243 located in the space may extend inward from the first part 241. The second part 243 may be located under (e.g., the −Z direction) the display 201. In an embodiment, the first part 241 and/or the second part 243 may be formed of metal and/or polymer.

In an embodiment, the first part 241 of the frame structure 240 forming the lateral surface of the electronic device 200 may be referred to as a lateral portion, a lateral member, a lateral structure, or a frame, and the second part 243 of the frame structure 240 supporting various components of the electronic device 200 may be referred to as a support portion, a support member, or a support structure.

In an embodiment, the first printed circuit board 250, the second printed circuit board 254, and the battery 270 may be coupled to the frame structure 240, respectively. For example, the first printed circuit board 250 and the second printed circuit board 254 may be fixedly disposed in the frame structure 240 through a coupling member such as a screw. For example, the battery 270 may be fixedly disposed on the frame structure 240 through an adhesive member (e.g., a double-sided tape). However, the disclosure is not limited by the above-described example.

In an embodiment, the display 201 may be disposed between the frame structure 240 and the front plate 202. For example, the front plate 202 may be disposed in a side (e.g., the +Z direction) of the display 201, and the frame structure 240 may be disposed in another side (e.g., the −Z direction).

In an embodiment, the front plate 202 may be coupled with the display 201. For example, the display 201 may be attached to a back surface of the front plate 202 through an optical adhesive member (e.g., an optically clear adhesive (OCA) or an optically clear resin (OCR)).

In an embodiment, the front plate 202 may be coupled with the frame structure 240. For example, the front plate 202 may include an outer periphery portion extending outside the display 201 when viewed in a z-axis direction. The outer periphery portion of the front plate 202 may be coupled to the frame structure 240 (e.g., the first part 241).

In an embodiment, a processor (e.g., the processor 120 of FIG. 1), memory (e.g., the memory 130 of FIG. 1), and/or an interface (e.g., the interface 177 of FIG. 1) may be disposed in the first printed circuit board 250 and/or the second printed circuit board 254. The processor may include, for example, one or more of a central processing unit, an application processor, a graphic processing unit, an image signal processor, a sensor hub processor, or a communication processor.

The memory may include, for example, volatile memory or non-volatile memory. The interface may include, for example, a high definition multimedia interface (HDMI), a universal serial bus (USB) interface, an SD card interface, and/or an audio interface. The interface may electrically or physically connect the electronic device 200 to an external electronic device, and may include a USB connector, an SD card/MMC connector, or an audio connector. In an embodiment, the first printed circuit board 250 and the second printed circuit board 254 may be operatively or electrically connected with each other through a connecting member (e.g., a flexible printed circuit board).

In an embodiment, the battery 270 may supply power to at least one component of the electronic device 200. For example, the battery 270 may include a rechargeable secondary battery or a fuel cell.

In an embodiment, the first camera module 205 (e.g., a front camera) may be disposed in at least a portion (e.g., the second part 243) of the frame structure 240 so that a lens may receive external light through a partial area (e.g., a camera area 237) of the front plate 202 (e.g., the front surface 200A of FIG. 2A).

In an embodiment, the second camera module 212 (e.g., a rear camera) may be disposed between the frame structure 240 and the rear plate 211. In an embodiment, the second camera module 212 may be electrically connected to the first printed circuit board 250 through a connecting member (e.g., a connector). In an embodiment, the second camera module 212 may be disposed so that a lens may receive external light through a camera area 284 of the rear plate 211 of the electronic device 200.

In an embodiment, the camera area 284 may be formed on a surface (e.g., the rear surface 200B of FIG. 2A) of the rear plate 211. In an embodiment, the camera area 284 may be formed to be at least partially transparent so that external light may be incident on the lens of the second camera module 212. In an embodiment, at least a portion of the camera area 284 may protrude from the surface of the rear plate 211 at a predetermined height. However, the disclosure is not limited thereto, and in an embodiment, the camera area 284 may form substantially the same plane as the surface of the rear plate 211.

In an embodiment, a housing 210 of the electronic device 200 may refer, for example, to a configuration or a structure forming at least a portion of an exterior of the electronic device 200. In this regard, at least a portion of the front plate 202, the frame structure 240, and/or the rear plate 211 forming the exterior of the electronic device 200, may be referred to as the housing 210 of the electronic device 200.

The electronic device 200 according to an embodiment may include an electronic component 280 located around the first printed circuit board 250. For example, the electronic component 280 may include a speaker (e.g., a receiver or an earpiece speaker) configured to output call sounds, but is not limited thereto.

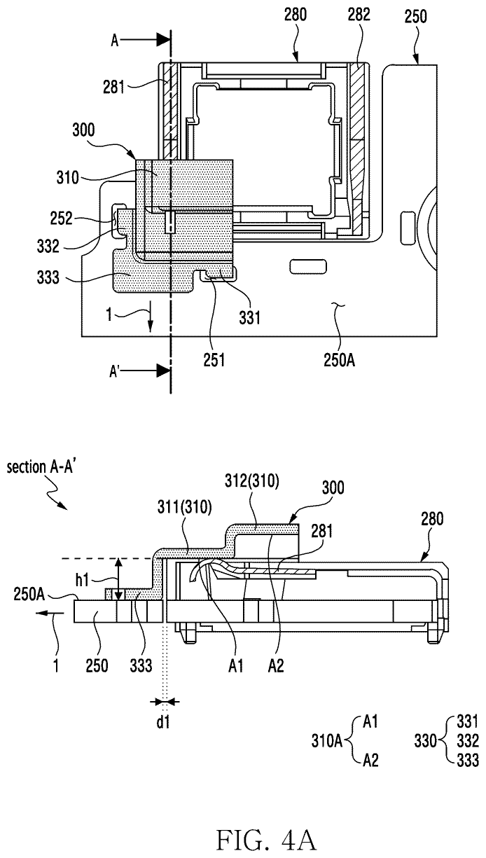

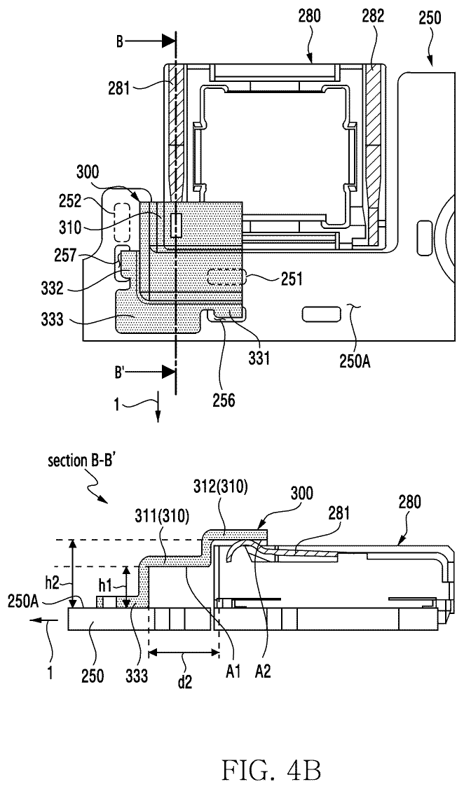

According to an embodiment, the electronic device 200 may include connectors 300-1 and 300-2 disposed on the first printed circuit board 250. The connectors 300-1 and 300-2 may be electrically connected to contacts, by contacting the contacts (or spring contacts) (e.g., a first contact 281 of FIG. 4A) such as a C-clip. For example, the contacts may be included in the electronic component 280. The connectors 300-1 and 300-2 electrically connected to the contacts of the electronic component 280, may be configured to transmit an electrical signal (e.g., an acoustic signal) for the electronic component 280 to operate. As an alternative example, the contacts may be configured independently of the electronic component 280. As a non-limiting example, the contacts may be electrically connected by contacting an antenna radiator (e.g., a conductive portion of the frame structure 240) of the electronic device 200. The connectors 300-1 and 300-2 may be configured to transmit and/or receive a RF signal to the contacts and/or from the contacts electrically connected to the antenna radiator.

As a non-limiting example, the connectors 300-1 and 300-2 may be coupled through a non-conductive material (e.g., an injection-molded material) located between the connectors 300-1 and 300-2 to electrically insulate the connectors 300-1 and 300-2.

According to a height relationship between the first printed circuit board 250 and the contacts, a different shape and/or a different size of the connectors 300-1 and 300-2 electrically connecting the first printed circuit board 250 and the contacts may be required. For example, in case that the contacts are positioned higher from the first printed circuit board 250, the connectors 300-1 and 300-2 may also need to provide a higher contact height. That is, connectors having various shapes and/or sizes may be required for each model of the electronic device 200, which may cause a problem of management and a cost by increasing the number of parts per model. Hereinafter, a structure of a connector capable of providing various contact heights according to a position in which the connector is coupled (or disposed) to the first printed circuit board 250 will be described.

In the following description, the same reference numerals may be given to the same or similar configurations, and an overlapping description for a configuration having the same reference numeral may not be repeated. In the description below referring to various examples, a reference numeral of another diagram may be referenced.

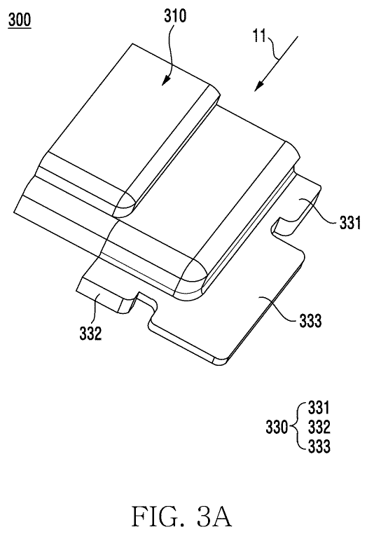

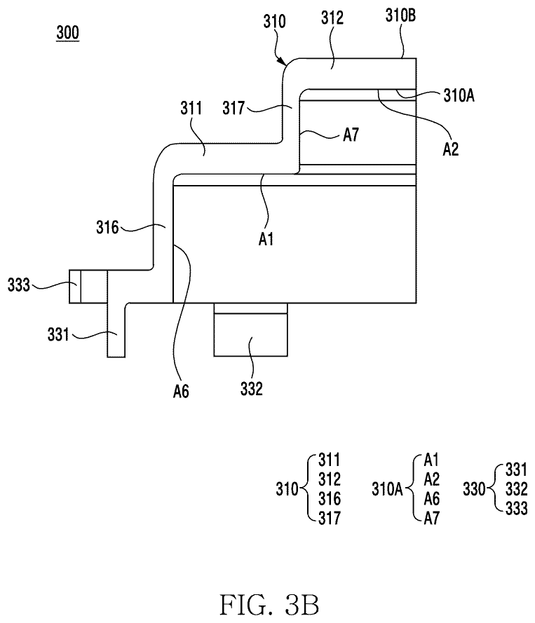

FIGS. 3A and 3B include a perspective view and a diagram illustrating a connector of an electronic device according to various embodiments. FIG. 3B may be a diagram in which a connector 300 of FIG. 3A is viewed in a direction 11. The connector 300 of FIGS. 3A and 3B may be an example of the above-described connectors 300-1 and 300-2.

Referring to FIG. 3A, the connector 300 of an electronic device 200 according to an embodiment may include a cover portion 310 and a leg portion 330 extending from the cover portion 310. The leg portion 330 may include a first leg portion 331, a second leg portion 332, and a third leg portion 333. In an embodiment, the cover portion 310 and the leg portion 330 of the connector 300 may be include a conductive material (e.g., metal). In this regard, the connector 300 may be referred to as a conductive connector, a conductive member, a conductive piece, a metal piece, a conductive bridge, and/or a metal bridge.

Referring to FIG. 3B, the cover portion 310 of the connector 300 according to an embodiment may include an inner surface 310A and an outer surface 310B opposite to the inner surface 310A.

In an embodiment, the inner surface 310A of the cover portion 310 may have a step shape (e.g., a cascading shape). The step shape of the inner surface 310A may include a plurality of flat surfaces positioned at different heights. For example, the inner surface 310A of the cover portion 310 may include a first flat surface A1 and a second flat surface A2 positioned at a different height from the first flat surface A1 and parallel to the first flat surface A1. For example, the second flat surface A2 may be positioned higher than the first flat surface A1. For example, the second flat surface A2 may be positioned farther from the leg portion 330 than the first flat surface A1 base on a direction perpendicular to the second flat surface A2. In an embodiment, the second flat surface A2 of the cover portion 310 may be located between the first flat surface A1 and the first leg portion 331 (e.g., when viewed in the direction perpendicular to the second flat surface A2).

In an embodiment, the inner surface 310A of the cover portion 310 may include a first connecting surface A6 extending from an edge of the leg portion 330 (e.g., the first leg portion 331) to an edge of the first flat surface A1. The first connecting surface A6 may have a different slope from the first flat surface A1. As a non-limiting example, the first connecting surface A6 may be perpendicular to the first flat surface A1.

In an embodiment, the inner surface 310A of the cover portion 310 may include a second connecting surface A7 extending from another edge of the first flat surface A1 to an edge of the second flat surface A2. The second connecting surface A7 may have a different slope from the first flat surface A1 and the second flat surface A2. As a non-limiting example, the second connecting surface A7 may be perpendicular to the first flat surface A1 and the second flat surface A2.

In an embodiment, the outer surface 310B of the cover portion 310 may have a shape corresponding to the inner surface 310A. For example, the outer surface 310B of the cover portion 310 may have a shape corresponding to the step shape of the inner surface 310A.

In an embodiment, the cover portion 310 may include a first horizontal portion 311, a second horizontal portion 312, a first connecting portion 316, and a second connecting portion 317.

For example, the first horizontal portion 311 may at least partially define the first flat surface A1 of the inner surface 310A. For example, the second horizontal portion 312 may at least partially define the second flat surface A2 of the inner surface 310A.

For example, the first connecting portion 316 may extend from the leg portion 330 (e.g., the first leg portion 331) of the connector 300 to the first horizontal portion 311 of the cover portion 310. The first connecting portion 316 may extend at a different slope from the first horizontal portion 311 to define the first connecting surface A6 of the inner surface 310A. As a non-limiting example, the first connecting portion 316 may be perpendicular to the first horizontal portion 311. In this case, the first connecting portion 316 may be referred to as a first vertical portion of the cover portion 310.

For example, the second connecting portion 317 may extend from a distal end of the first horizontal portion 311 to a distal end of the second horizontal portion 312. The second connecting portion 317 may extend at a different slope from the first horizontal portion 311 and the second horizontal portion 312 to define the second connecting surface A7 of the inner surface 310A. As a non-limiting example, the second connecting portion 317 may be perpendicular to the first horizontal portion 311 and the second horizontal portion 312. In this case, the second connecting portion 317 may be referred to as a second vertical portion of the cover portion 310.

FIGS. 4A and 4B are cross-sectional views illustrating a connector connected to a printed circuit board and an electronic component according to various embodiments.

FIG. 4A illustrates a connector 300 and a first printed circuit board 250 coupled in a first position, and FIG. 4B illustrates the connector 300 and the first printed circuit board 250 coupled in a second position different from the first position. In FIGS. 4A and 4B, cross-sectional views taken along line A-A′ and line B-B′ are illustrated together. A direction 1 illustrated in FIGS. 4A and 4B may be, for example, parallel to the line A-A′ (and the line B-B′), and may be a direction from an electronic component 280 toward the first printed circuit board 250.

Referring to FIGS. 4A and 4B, the electronic component 280 according to an embodiment may include a first contact 281 and a second contact 282. The first contact 281 and the second contact 282 may be configured to have elasticity. As a non-limiting example, the first contact 281 and the second contact 282 may include a C-clip. The first contact 281 and the second contact 282 may be referred to as a spring contact, respectively.

The connector 300 according to an embodiment may be disposed on the first printed circuit board 250. For example, the connector 300 may be disposed on a surface 250A of the first printed circuit board 250. The leg portion 330 of the connector 300 may be coupled to the first printed circuit board 250. For example, each of the first leg portion 331 and the second leg portion 332 of the connector 300 may be inserted into the first printed circuit board 250. The first leg portion 331 and the second leg portion 332 inserted into the first printed circuit board 250 may be coupled to the first printed circuit board 250 by soldering (e.g., a through hole mount or a dual inline package (DIP)). For example, the third leg portion 333 may be seated on the surface 250A of the first printed circuit board 250. The third leg portion 333 may be coupled to the first printed circuit board 250 by soldering (e.g., a surface mount). In this regard, the leg portion 330 of the connector 300 may be referred to as a soldering portion of the connector 300. At least a portion of the cover portion 310 of the connector 300 may be spaced apart from the first printed circuit board 250 through the leg portion 330.

In an embodiment, the inner surface 310A of the cover portion 310 of the connector 300 may be in contact with the first contact 281 of the electronic component 280. In an embodiment, the connector 300 may be configured to provide a different contact height according to a position coupled (or disposed) to the first printed circuit board 250.

For example, referring to FIG. 4A, the connector 300 may be coupled to the first printed circuit board 250 in the first position. For example, the first leg portion 331 of the connector 300 may be at least partially inserted into a first hole 251 of the first printed circuit board 250, and the second leg portion 332 may be at least partially inserted into a second hole 252 of the first printed circuit board 250. In the first position, a distance between the leg portion 330 (e.g., the third leg portion 333) and the electronic component 280 (or the first contact 281) based on the direction 1 may be a first distance d1.

In the first position, the first contact 281 may be in contact with a first flat surface A1 from among the first flat surface A1 and a second flat surface A2 of the cover portion 310 of the connector 300. In the first position, the connector 300 may provide a first contact height h1. The first contact height h1 may be, for example, a first vertical distance from the surface 250A of the first printed circuit board 250 to the first flat surface A1 of the cover portion 310 with which the first contact 281 is in contact. The first vertical distance may be, for example, a distance based on a direction perpendicular to the first printed circuit board 250.

For example, referring to FIG. 4B, the connector 300 may be coupled to the first printed circuit board 250 in the second position different from the first position. For example, the first leg portion 331 of the connector 300 may be at least partially inserted into a third hole 256 of the first printed circuit board 250, and the second leg portion 332 may be at least partially inserted into a fourth hole 257 of the first printed circuit board 250. The third hole 256 may further move in the direction 1 from the first hole 251, and the fourth hole 257 may further move in the direction 1 from the second hole 252. The connector 300 of the second position inserted into the third hole 256 and the fourth hole 257 may move further in the direction 1 compared to the connector 300 of the first position inserted into the first hole 251 and the second hole 252.

In the second position, a distance between the leg portion 330 (e.g., the third leg portion 333) and the electronic component 280 (or the first contact 281) based on the direction 1 may be a second distance d2. The second distance d2 in the second position may be greater than the first distance d1 in the first position.

In the second position, the first contact 281 may be in contact with the second flat surface A2 from among the first flat surface A1 and the second flat surface A2 of the cover portion 310 of the connector 300. In the second position, the connector 300 may provide a second contact height h2. The second contact height h2 in the second position may be greater than the first contact height h1 in the first position. The second contact height h2 may be, for example, a second vertical distance from the surface 250A of the first printed circuit board 250 to the second flat surface A2 of the cover portion 310 with which the first contact 281 is in contact. The second vertical distance may be, for example, a distance based on a direction perpendicular to the first printed circuit board 250.

As described above, a step shape of the cover portion 310 of the connector 300 may provide a different contact height according to a position in which the connector 300 is coupled to the first printed circuit board 250. Accordingly, a connector used for each model having a different contact height may be standardized.

Although not illustrated, the electronic device 200 according to an embodiment may include a bracket (e.g., a second part 243 of a frame structure 240) on which the electronic component 280 is seated. In an embodiment, the cover portion 310 of the connector 300 may depress the first contact 281 in a direction of the bracket on which the electronic component 280 is seated. Accordingly, the electronic component 280 may be more stably seated on the bracket.

Although not illustrated, the electronic device 200 may include another connector in contact with the second contact 282 of the electronic component 280. With respect to the other connector, a description provided with reference to the connector 300 may be applied in substantially the same or corresponding manner.

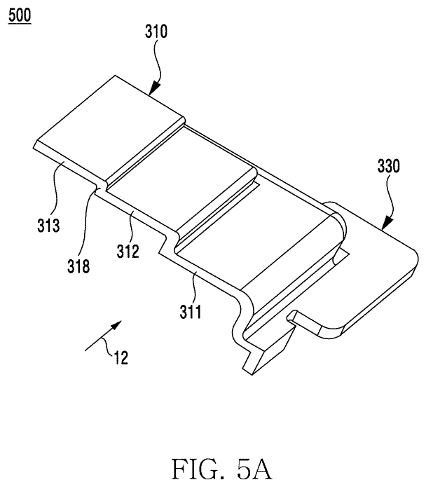

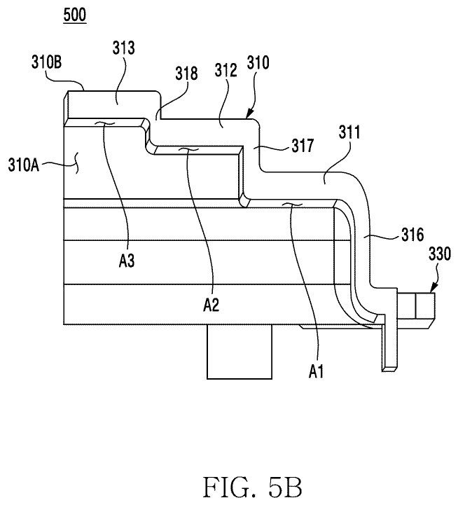

FIGS. 5A and 5B include perspective and cross-sectional views illustrating a connector according to various embodiments. FIG. 5B may be a diagram of a connector 500 of FIG. 5A viewed in a direction 12.

The cover portion 310 of the connector 300 described above has a step shape configured with two stages (e.g., a first flat surface A1 and a second flat surface A2), but the disclosure is not limited thereto, and the step shape of the cover portion 310 may include two or more stages.

For example, referring to FIGS. 5A and 5B, according to an embodiment, the cover portion 310 of the connector 500 may further include a third horizontal portion 313 and a third connecting portion 318. The third connecting portion 318 may extend from another distal end of the second horizontal portion 312 to a distal end of the third horizontal portion 313. The third connecting portion 318 may extend at a different slope from the second horizontal portion 312 and the third horizontal portion 313.

In an embodiment, an inner surface 310A of the cover portion 310 may further include a third flat surface A3 defined by the third horizontal portion 313. The third flat surface A3 may be parallel to the first flat surface A1 and the second flat surface A2. The third flat surface A3 may be positioned higher than the first flat surface A1 and the second flat surface A2. For example, the third flat surface A3 may be positioned farther from a leg portion 330 than the first flat surface A1 and the second flat surface A2 based on a direction perpendicular to the third flat surface A3.

According to an embodiment, the first flat surface A1, the second flat surface A2, or the third flat surface A3 of the connector 500 may be selectively in contact with a first contact 281 of an electronic component 280 according to a position in which the connector 500 is coupled to a first printed circuit board 250.

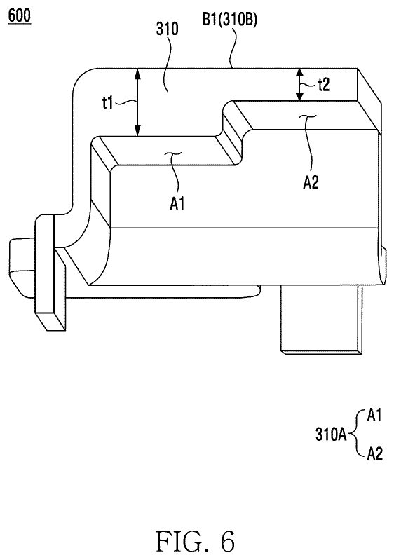

FIG. 6 is a perspective view illustrating a connector according to various embodiments.

The outer surface 310B of the cover portion 310 of the connectors 300 and 500 described above is configured to correspond to the step shape of the inner surface 310A, but the disclosure is not limited thereto. For example, the step shape may be formed only on the inner surface 310A from among the inner surface 310A and the outer surface 310B of the cover portion 310.

For example, referring to FIG. 6, according to an embodiment, the outer surface 310B of the connector 600 may include a flat surface B1. The flat surface B1 of the outer surface 310B may be opposite to both a first flat surface A1 and a second flat surface A2 of the inner surface 310A. As a non-limiting example, the flat surface B1 of the outer surface 310B may be parallel to the first flat surface A1 and the second flat surface A2 of the inner surface 310A.

In an embodiment, the cover portion 310 of the connector 600 may include portions having different thicknesses.

For example, the cover portion 310 may include a first portion having a first thickness t1 defined as a distance between the flat surface B1 of the outer surface 310B and the first flat surface A1 of the inner surface 310A, and a second portion having a second thickness t2 defined as a distance between the flat surface B1 of the outer surface 310B and the second flat surface A2 of the inner surface 310A. The first thickness t1 may be greater than the second thickness t2, but the disclosure not limited thereto.

A description provided with reference to FIG. 6 may be applied to inner surfaces 710A, 910A, 1110A, or 1310A of connectors 700, 900, 1100, or 1300 to be described later and outer surfaces opposite to the inner surfaces in substantially the same or corresponding manner.

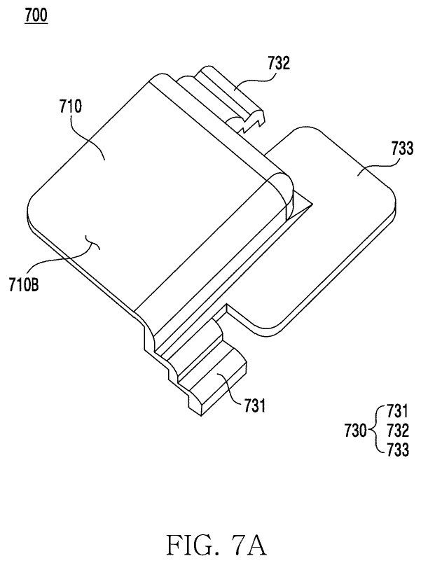

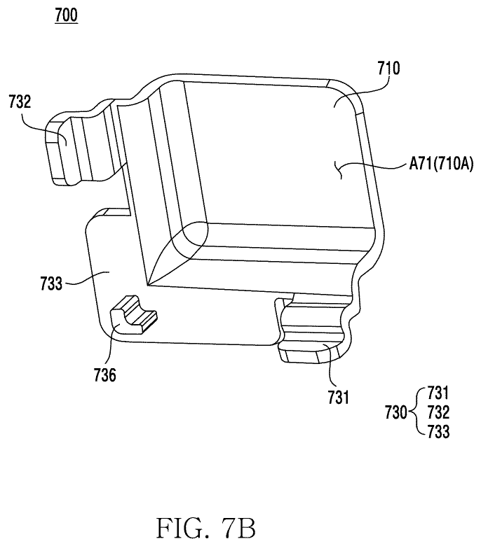

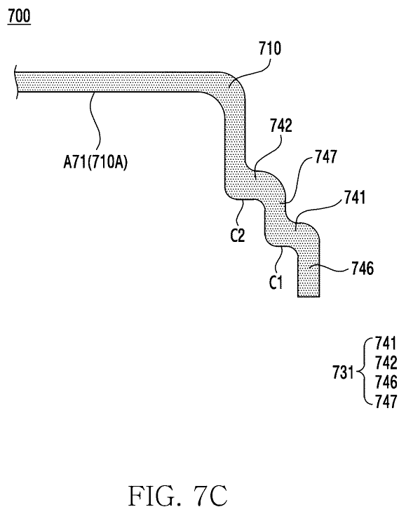

FIGS. 7A and 7B are perspective views illustrating a connector according to various embodiments. FIG. 7C is a diagram illustrating a leg portion of a connector according to various embodiments.

A connector 700 of FIGS. 7A, 7B, and 7C may be an example of the connectors 300-1 and 300-2 described above.

Referring to FIG. 7A, the connector 700 of an electronic device 200 according to an embodiment may include a cover portion 710 and a leg portion 730 extending from the cover portion 710. The leg portion 730 may include a first leg portion 731, a second leg portion 732, and a third leg portion 733. In an embodiment, the cover portion 710 and the leg portion 730 of the connector 700 may be formed of a conductive material (e.g., metal). In this regard, the connector 700 may be referred to as a conductive connector, a conductive member, a conductive piece, a metal piece, a conductive bridge, or a metal bridge.

Referring to FIGS. 7A and 7B, according to an embodiment, the cover portion 710 of the connector 700 may include an inner surface 710A and an outer surface 700B opposite to the inner surface 710A. According to an embodiment, the inner surface 710A of the cover portion 710 may include a flat surface A71.

Referring to FIG. 7C, according to an embodiment, the first leg portion 731 of the connector 700 may include a step structure (or a step shape). For example, the step structure of the first leg portion 731 may include a plurality of horizontal portions positioned at different heights. For example, the first leg portion 731 of the connector 700 may include a first horizontal portion 741 and a second horizontal portion 742 spaced apart from the first horizontal portion 741. The second horizontal portion 742 may be positioned higher than the first horizontal portion 741. For example, the second horizontal portion 742 may be closer to the cover portion 710 of the connector 700 than the first horizontal portion 741.

In an embodiment, the first leg portion 731 of the connector 700 may further include a first vertical portion 746 and a second vertical portion 747. The first vertical portion 746 may extend from a distal end of the first horizontal portion 741. The second vertical portion 747 may connect the first horizontal portion 741 and the second horizontal portion 742 by extending from another distal end of the first horizontal portion 741 to a distal end of the second horizontal portion 742. The second horizontal portion 742 may connect the cover portion 710 and the first leg portion 731 of the connector 700 by extending from the second vertical portion 747 to the cover portion 710.

In an embodiment, the first leg portion 731 of the connector 700 may include a first flat surface C1 defined by the first horizontal portion 741 and a second flat surface C2 defined by the second horizontal portion 742. The second flat surface C2 may be parallel to the first flat surface C1. The second flat surface C2 may be positioned higher than the first flat surface C1. For example, the second flat surface C2 may be closer to the cover portion 710 of the connector 700 than the first flat surface C1. The first flat surface C1 and the second flat surface C2 may be parallel to the flat surface A71 of the cover portion 710, but the disclosure not limited thereto.

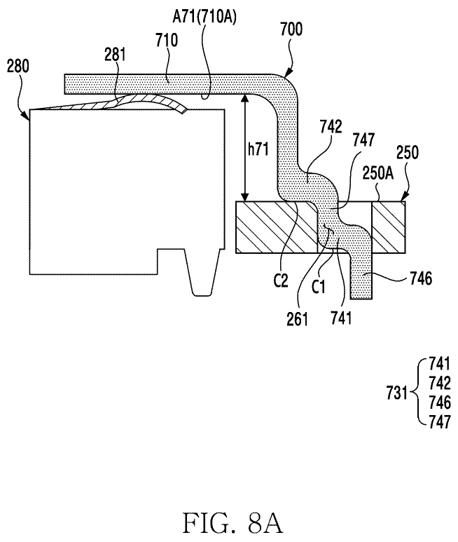

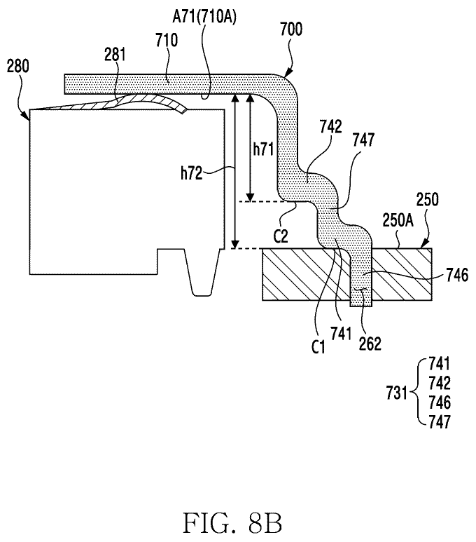

FIGS. 8A and 8B are diagrams illustrating a connector connected to a printed circuit board and an electronic component according to various embodiments.

FIG. 8A illustrates a connector 700 and a first printed circuit board 250 coupled in a first position, and FIG. 8B illustrates the connector 700 and the first printed circuit board 250 coupled in a second position different from the first position.

Referring to FIGS. 8A and 8B, according to an embodiment, the connector 700 may be disposed on the first printed circuit board 250. For example, the connector 700 may be disposed on a surface 250A of the first printed circuit board 250. A first leg portion 731 of the connector 700 may be coupled to the first printed circuit board 250. For example, a portion of the first leg portion 731 of the connector 700 may be inserted into the first printed circuit board 250, and another portion of the first leg portion 731 may be disposed on the surface 250A of the first printed circuit board 250. The portion of the first leg portion 731 inserted into the first printed circuit board 250 and the other portion of the first leg portion 731 disposed on the surface 250A of the first printed circuit board 250 may be coupled to the first printed circuit board 250 by soldering. The connector 700 may be supported by coupling the first leg portion 731 to the first printed circuit board 250. At least a portion of a cover portion 710 of the connector 700 may be spaced apart from the first printed circuit board 250 through a leg portion 730 (e.g., the first leg portion 731).

In an embodiment, an inner surface 710A (e.g., a flat surface A71) of the cover portion 710 of the connector 700 may be in contact with a first contact 281 of an electronic component 280. In an embodiment, the connector 700 may be configured to provide a different contact height according to a position coupled (or disposed) to the first printed circuit board 250.

For example, referring to FIG. 8A, the connector 700 may be coupled to the first printed circuit board 250 in the first position. For example, a second horizontal portion 742 of the first leg portion 731 may be in contact with the surface 250A of the first printed circuit board 250, and a first horizontal portion 741, a first vertical portion 746, and a second vertical portion 747 may be located within a first hole 261 of the first printed circuit board 250. In an embodiment, a portion of the first vertical portion 746 of the first leg portion 731 may be located within the first hole 261 of the first printed circuit board 250, and another portion of the first vertical portion 746 may protrude out of a surface opposite to the surface 250A of the first printed circuit board 250, but the disclosure not limited thereto.

In an embodiment, in the first position, the surface 250A of the first printed circuit board 250 may be in contact with a second flat surface C2 from among a first flat surface C1 and the second flat surface C2 of the first leg portion 731. As the second flat surface C2 is in contact with the surface 250A of the first printed circuit board 250, the connector 700 may be supported by the first printed circuit board 250.

In an embodiment, in the first position, the connector 700 may provide a first contact height h71. The first contact height h71 may be a first vertical distance from the flat surface A71 of the cover portion 710 in contact with the first contact 281 of the electronic component 280 to the surface 250A (or the second flat surface C2 of the first leg portion 731 in contact therewith) of the first printed circuit board 250. The first vertical distance may be, for example, a distance based on a direction perpendicular to the first printed circuit board 250.

For example, referring to FIG. 8B, the connector 700 may be coupled to the first printed circuit board 250 in the second position different from the first position. For example, in the second position, the first leg portion 731 of the connector 700 may be inserted shallower into the first printed circuit board 250 than the first leg portion 731 of the first position. For example, the first vertical portion 746 of the first leg portion 731 may be positioned within a second hole 262 of the first printed circuit board 250, and the first horizontal portion 741, the second vertical portion 747, and the second horizontal portion 742 may be located outside the second hole 262 of the first printed circuit board 250. In an embodiment, a diameter of the second hole 262 of the first printed circuit board 250 may be smaller than the first hole 261. In the second position, the first horizontal portion 741 of the first leg portion 731 may be in contact with the surface 250A of the first printed circuit board 250.

In an embodiment, in the second position, the surface 250A of the first printed circuit board 250 may be in contact with the first flat surface C1 from among the first flat surface C1 and the second flat surface C2 of the first leg portion 731. As the first flat surface C1 is in contact with the surface 250A of the first printed circuit board 250, the connector 700 may be supported by the first printed circuit board 250.

In an embodiment, in the second position, the connector 700 may provide a second contact height h72. The second contact height h72 may be a second vertical distance from the flat surface A71 of the cover portion 710 in contact with the first contact 281 of the electronic component 280 to the surface 250A (or the first flat surface C1 of the first leg portion 731 in contact therewith) of the first printed circuit board 250. The second vertical distance may be, for example, a distance based on the direction perpendicular to the first printed circuit board 250. In an embodiment, the second contact height h72 in the second position may be greater than a first contact height h71 in the first position. For example, the second contact height h72 may be greater than the first contact height h71 by a height difference between the first flat surface C1 and the second flat surface C2.

The above-described description of the first leg portion 731 of the connector 700 may be applied to a second leg portion 732 in substantially the same or corresponding manner. For example, the second leg portion 732 of the connector 700 may include a step structure having a plurality of horizontal portions (e.g., the first horizontal portion 741 and the second horizontal portion 742) positioned at different heights. For example, the plurality of horizontal portions of the second leg portion 732 of the connector 700 may define a third flat surface (e.g., the first flat surface C1) and a fourth flat surface (e.g., the second flat surface C2) positioned at a different height from the third flat surface. The third flat surface of the second leg portion 732 may be positioned at substantially the same height as the first flat surface C1 of the first leg portion 731, and the fourth flat surface of the second leg portion 732 may be positioned at substantially the same height as the second flat surface C2 of the first leg portion 731. In the first position, the surface 250A of the first printed circuit board 250 may be in contact with the fourth flat surface from among the third flat surface and the fourth flat surface of the second leg portion 732 of the connector 700. In the second position, the surface 250A of the first printed circuit board 250 may be in contact with the third flat surface from among the third flat surface and the fourth flat surface the second leg portion 732 of the connector 700.

As described above, a step shape of the leg portion 730 of the connector 700 may provide a different contact height according to a position in which the connector 700 is coupled to the first printed circuit board 250. Accordingly, a connector used for each model having a different contact height may be standardized.

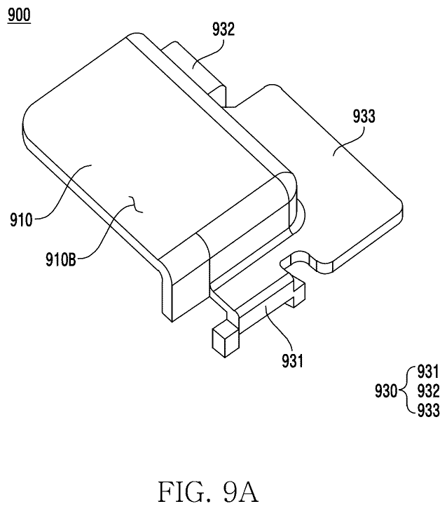

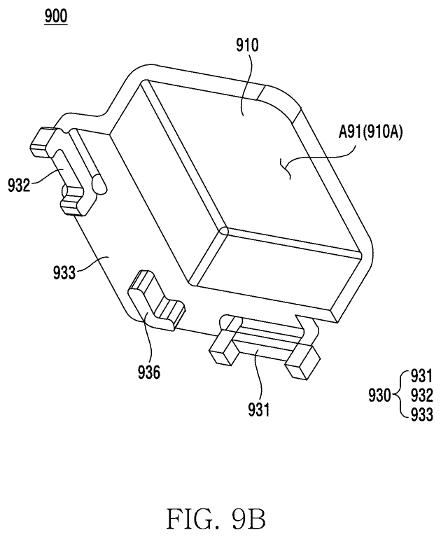

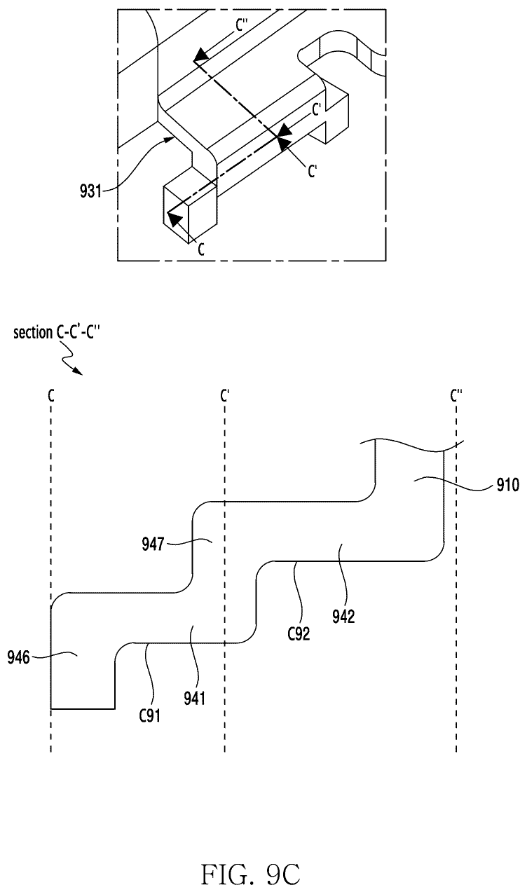

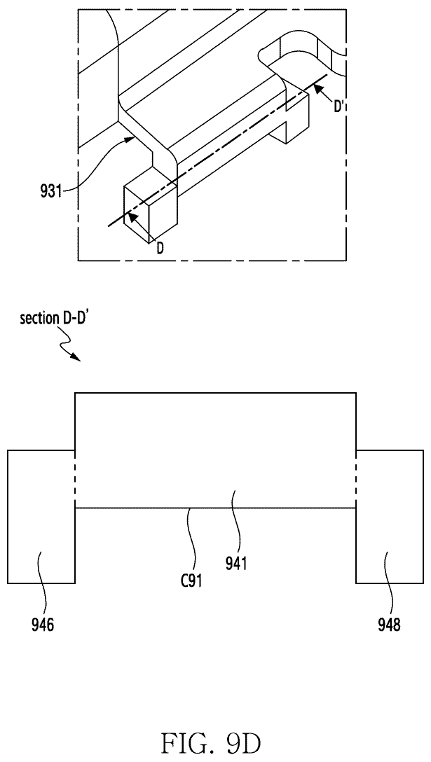

FIGS. 9A and 9B are diagrams illustrating a connector according to various embodiments. FIGS. 9C and 9D are diagrams illustrating a leg portion of a connector according to various embodiments.

A connector 900 of FIGS. 9A, 9B, 9C, and 9D may illustrate an example of the connectors 300-1 and 300-2 described above.

Referring to FIG. 9A, the connector 900 of an electronic device 200 according to an embodiment may include a cover portion 910 and a leg portion 930 extending from the cover portion 910. The leg portion 930 may include a first leg portion 931, a second leg portion 932, and a third leg portion 933. In an embodiment, the cover portion 910 and the leg portion 930 of the connector 900 may be formed of a conductive material (e.g., metal). In this regard, the connector 900 may be referred to as a conductive connector, a conductive member, a conductive piece, a metal piece, a conductive bridge, or a metal bridge.

Referring to FIGS. 9A and 9B, according to an embodiment, the cover portion 910 of the connector 900 may include an inner surface 910A and an outer surface 910B opposite to the inner surface 910A. According to an embodiment, the inner surface 910A of the cover portion 910 may include a flat surface A91.

Referring to FIG. 9C, according to an embodiment, the first leg portion 931 of the connector 900 may include a step structure (or a step shape). For example, the step structure of the first leg portion 931 may include a plurality of horizontal portions positioned at different heights. For example, the first leg portion 931 of the connector 900 may include a first horizontal portion 941 and a second horizontal portion 942 spaced apart from the first horizontal portion 941. The second horizontal portion 942 may be positioned higher than the first horizontal portion 941. For example, the second horizontal portion 942 may be closer to the cover portion 910 of the connector 900 than the first horizontal portion 941.

In an embodiment, the first leg portion 931 of the connector 900 may further include a first vertical portion 946 and a second vertical portion 947. The first vertical portion 946 may extend from a distal end of the first horizontal portion 941. The second vertical portion 947 may connect the first horizontal portion 941 and the second horizontal portion 942 by extending from another distal end of the first horizontal portion 941 to a distal end of the second horizontal portion 942. The second horizontal portion 942 may connect the cover portion 910 and the first leg portion 931 of the connector 900 by extending from the second vertical portion 947 to the cover portion 910.

In an embodiment, the first leg portion 931 of the connector 900 may include a first flat surface C91 defined by the first horizontal portion 941 and a second flat surface C92 defined by the second horizontal portion 942. The second flat surface C92 may be parallel to the first flat surface C91. The second flat surface C92 may be positioned higher than the first flat surface C91. For example, the second flat surface C92 may be closer to the cover portion 910 of the connector 900 than the first flat surface C91. The first flat surface C91 and the second flat surface C92 may be parallel to the flat surface A91 of the cover portion 910, but the disclosure is not limited thereto.

Referring to FIG. 9D, according to an embodiment, the first leg portion 931 of the connector 900 may include a third vertical portion 948. The third vertical portion 948 may extend from the other distal end of the first horizontal portion 941 to face the first vertical portion 946.

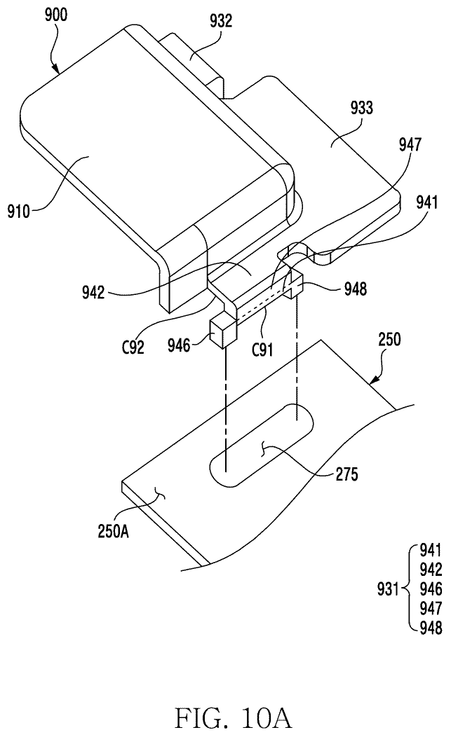

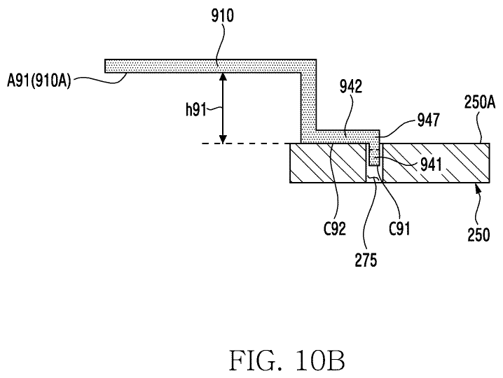

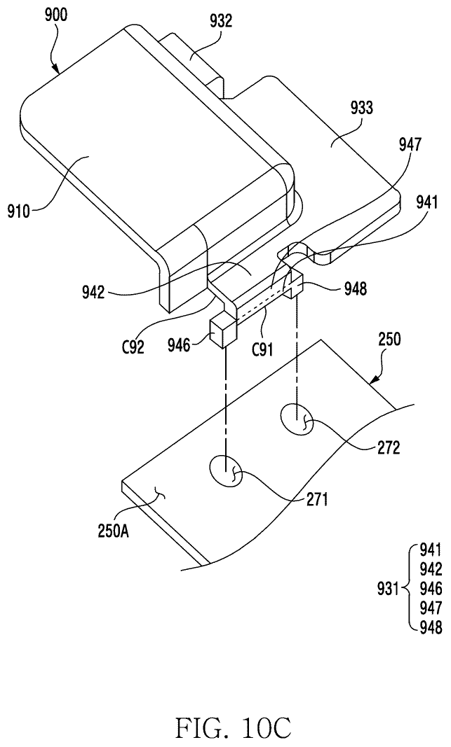

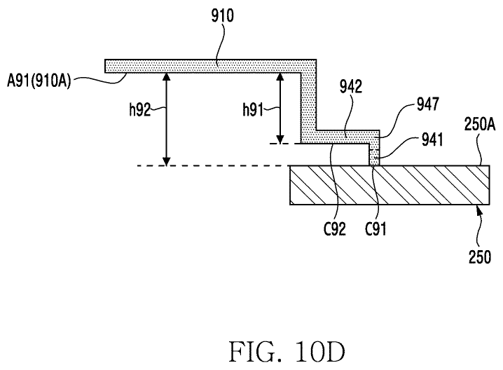

FIGS. 10A, 10B, 10C, and 10D are diagrams including various views illustrating a connector connected to a printed circuit board and an electronic component according to various embodiments.

FIGS. 10A and 10B illustrate a connector 900 and a first printed circuit board 250 coupled in a first position, and FIGS. 10C and 10D illustrate the connector 900 and the first printed circuit board 250 coupled in a second position different from the first position.

Referring to FIGS. 10A, 10B, 10C, and 10D, according to an embodiment, the connector 900 may be disposed on the first printed circuit board 250. For example, the connector 900 may be disposed on a surface 250A of the first printed circuit board 250. A first leg portion 931 of the connector 900 may be coupled to the first printed circuit board 250. For example, a portion of the first leg portion 931 of the connector 900 may be inserted into the first printed circuit board 250, and another portion of the first leg portion 931 may be disposed on the surface 250A of the first printed circuit board 250. The portion of the first leg portion 931 inserted into the first printed circuit board 250 and the other portion of the first leg portion 931 disposed on the surface 250A of the first printed circuit board 250, may be coupled to the first printed circuit board 250 by soldering. The connector 900 may be supported by coupling the first leg portion 931 to the first printed circuit board 250. At least a portion of a cover portion 910 of the connector 900 may be spaced apart from the first printed circuit board 250 through a leg portion 930 (e.g., the first leg portion 931).

Although not illustrated, an inner surface 910A (e.g., a flat surface A91) of the cover portion 910 of the connector 900 may be in contact with a first contact 281 of an electronic component 280. In an embodiment, the connector 900 may be configured to provide a different contact height according to a position coupled (or disposed) to the first printed circuit board 250.

For example, referring to FIGS. 10A and 10B, the connector 900 may be coupled to the first printed circuit board 250 in the first position. For example, a second horizontal portion 942 of the first leg portion 931 may be supported by contacting the surface 250A of the first printed circuit board 250. In addition, a first horizontal portion 941, a first vertical portion 946, a second vertical portion 947, and a third vertical portion 948 of the first leg portion 931 may be located within a hole 275 of the first printed circuit board 250.

Referring to FIG. 10B, in the first position, the surface 250A of the first printed circuit board 250 may be in contact with a second flat surface C92 from among a first flat surface C91 and the second flat surface C92 of the first leg portion 930. As the second flat surface C92 is in contact with the surface 250A of the first printed circuit board 250, the connector 900 may be supported by the first printed circuit board 250.

In an embodiment, in the first position, the connector 900 may provide a first contact height h91. The first contact height h91 may be a first vertical distance from the flat surface A91 of the cover portion 910 in contact with the first contact 281 of the electronic component 280 to the surface 250A (or the second flat surface C92 of the first leg portion 931 in contact therewith) of the first printed circuit board 250. The first vertical distance may be, for example, a distance based on a direction perpendicular to the first printed circuit board 250.

For example, referring to FIGS. 10C and 10D, the connector 900 may be coupled to the first printed circuit board 250 in the second position different from the first position. For example, in the second position, the first leg portion 931 of the connector 900 may be inserted shallower into the first printed circuit board 250 than the first leg portion 931 of the first position. For example, the first vertical portion 946 of the first leg portion 931 may be located within a first hole 271 of the first printed circuit board 250, and the third vertical portion 948 of the first leg portion 931 may be located within a second hole 272 of the first printed circuit board 250. In addition, in the second position, the first horizontal portion 941 between the first vertical portion 946 and the third vertical portion 948 of the first leg portion 931 may be supported by contacting the surface 250A of the first printed circuit board 250. The second vertical portion 947 and the second horizontal portion 942 of the first leg portion 931 extending from the first horizontal portion 941 toward the cover portion 910, may be located outside the first hole 271 and the second hole 272 of the first printed circuit board 250.

Referring to FIG. 10D, in the second position, the surface 250A of the first printed circuit board 250 may be in contact with the first flat surface C91 from among first flat surface C91 and the second flat surface C92 of the first leg portion 930. As the first flat surface C91 is in contact with the surface 250A of the first printed circuit board 250, the connector 900 may be supported by the first printed circuit board 250.

In an embodiment, in the second position, the connector 900 may provide a second contact height h92. The second contact height h92 may be a second vertical distance from the flat surface A91 of the cover portion 910 in contact with the first contact 281 of the electronic component 280 to the surface 250A (or the first flat surface C91 of the first leg portion 931 in contact therewith) of the first printed circuit board 250. The second vertical distance may be, for example, a distance based on the direction perpendicular to the first printed circuit board 250. In an embodiment, the second contact height h92 in the second position may be greater than the first contact height h91 in the first position. For example, the second contact height h92 may be greater than the first contact height h91 by a height difference between a first flat surface C1 and a second flat surface C2.

The above-described description of the first leg portion 931 of the connector 900 may be applied to the second leg portion 932 in substantially the same or corresponding manner. For example, the second leg portion 932 of the connector 900 may include a step structure with a plurality of horizontal portions (e.g., the first horizontal portion 941 and the second horizontal portion 942) positioned at different heights. For example, the plurality of horizontal portions of the second leg portion 932 of the connector 900 may define a third flat surface (e.g., the first flat surface C91) and a fourth flat surface (e.g., the second flat surface C92) positioned at a different height from the third flat surface. The third flat surface of the second leg portion 932 may be positioned at substantially the same height as the first flat surface C91 of the first leg portion 931, and the fourth flat surface of the second leg portion 932 may be positioned at substantially the same height as the second flat surface C92 of the first leg portion 931. In the first position, the surface 250A of the first printed circuit board 250 may be in contact with the fourth flat surface from among the third flat surface and the fourth flat surface of the second leg portion 932 of the connector 900. In the second position, the surface 250A of the first printed circuit board 250 may be in contact with the third flat surface from among the third flat surface and the fourth flat surface of the second leg portion 932 of the connector 900.

As described above, the step shape of the leg portion 930 of the connector 900 may provide a different contact height according to a position in which the connector 900 is coupled to the first printed circuit board 250. Accordingly, a connector used for each model having a different contact height may be standardized.

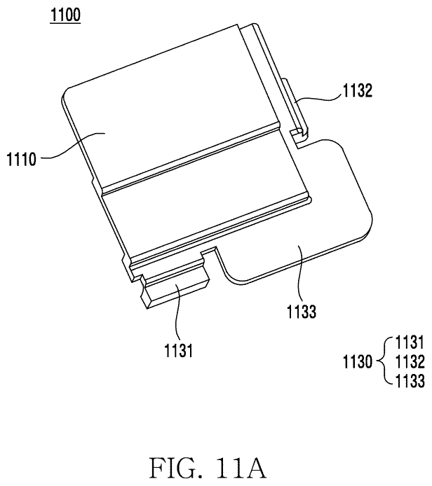

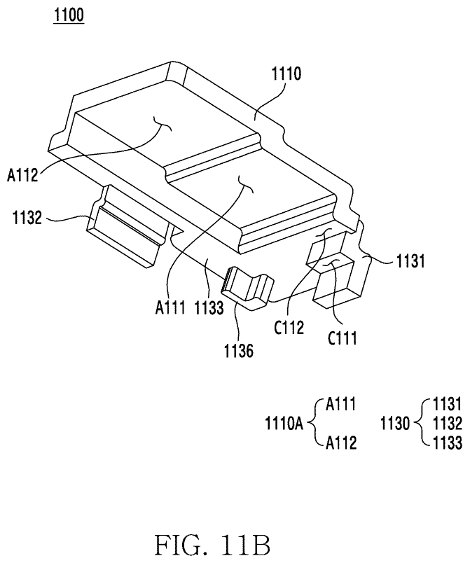

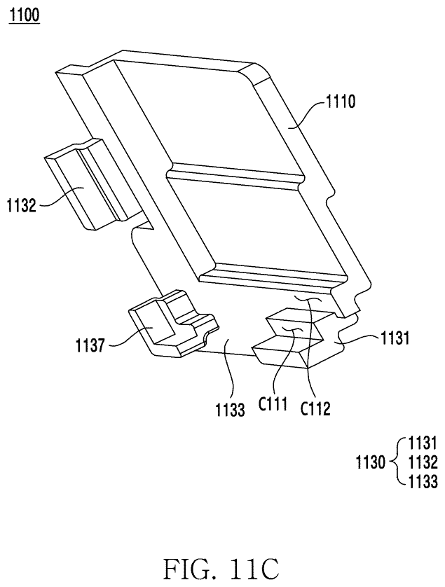

FIGS. 11A, 11B, and 11C are various perspective views illustrating a connector according to various embodiments.

A connector 1100 of FIGS. 11A, 11B, and 11C may be an example of the above-described connectors 300-1 and 300-2.

Referring to FIGS. 11A and 11B, the connector 1100 of an electronic device 200 according to an embodiment may include a cover portion 1110 and a leg portion 1130 extending from the cover portion 1110. The leg portion 1130 may include a first leg portion 1131, a second leg portion 1132, and a third leg portion 1133. In an embodiment, the cover portion 1110 and the leg portion 1130 of the connector 1100 may be formed of a conductive material (e.g., metal). In this regard, the connector 1100 may be referred to as a conductive connector, a conductive member, a conductive piece, a metal piece, a conductive bridge, or a metal bridge.

In an embodiment, with respect to the cover portion 1110 of the connector 1100, the above-described description of the cover portion 310 of the connector 300 may be applied in substantially the same or corresponding manner. For example, referring to FIG. 11B, an inner surface 1110A of the cover portion 1110 of the connector 1100 may have a step shape. For example, the step shape of the inner surface 1110A of the cover portion 1110 may include a plurality of flat surfaces positioned at different heights. For example, the inner surface 1110A of the cover portion 1110 may include a first flat surface A111 (e.g., a first flat surface A1) and a second flat surface A112 (e.g., a second flat surface A2) positioned at a different height from the first flat surface A111 and parallel to the first flat surface A111. For example, the second flat surface A112 may be positioned higher than the first flat surface A111.

In an embodiment, with respect to the leg portion 1130 of the connector 1100, the above-described description of the leg portion 730 of the connector 700 or the leg portion 930 of the connector 900 may be applied in substantially the same or corresponding manner. For example, with respect to the first leg portion 1131 of the connector 1100, the above-described description of the first leg portion 731 of the connector 700 or the first leg portion 931 of the connector 900 may be applied in substantially the same or corresponding manner. For example, the first leg portion 1131 of the connector 1100 may include a step structure. For example, the step structure of the first leg portion 1131 may include a first horizontal portion (e.g., a first horizontal portion 741 or a first horizontal portion 941) that defines a first flat surface C111 (e.g., a first flat surface C71 or a first flat surface C91), and may include a second horizontal portion (e.g., a second horizontal portion 742 or a second horizontal portion 942) that defines a second flat surface C112 (e.g., a second flat surface C72). The above-described description of the first leg portion 1131 of the connector 1100 may be applied to the second leg portion 1132 in substantially the same or corresponding manner.

Referring to 11B, according to an embodiment, the connector 1100 may further include a protruding portion 1136 formed on the third leg portion 1133. The protruding portion 1136 may be coupled by being inserted into the first printed circuit board 250. Accordingly, a coupling force between the first printed circuit board 250 and the connector 1100 may be improved.

In an embodiment, the protruding portion 1136 may extend straight in a vertical direction on the third leg portion 1133, but the disclosure is not limited thereto. For example, referring to FIG. 11C, the connector 1100 may further include a protruding portion 1137 having a step structure, like the first leg 1131. The step structure of the protruding portion 1137 extending from the third leg portion 1133 may define a flat surface having the same height as the first flat surface C111 of the first leg portion 1131. In addition, the third leg portion 1133 may define a flat surface having the same height as the second flat surface C112 of the first leg portion 1131.

In an embodiment, the connectors 300, 500, 600, 700, or 900 described above may further include a protruding portion formed in the third leg portion 331, 731, or 931, such as the protruding portions 1136 or 1137.

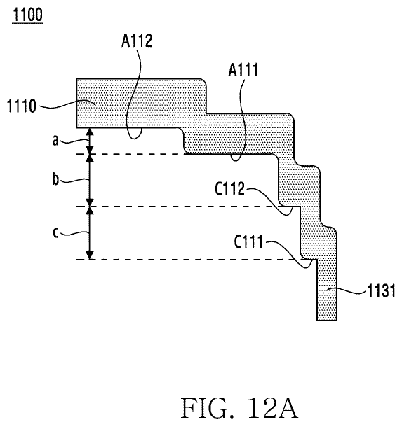

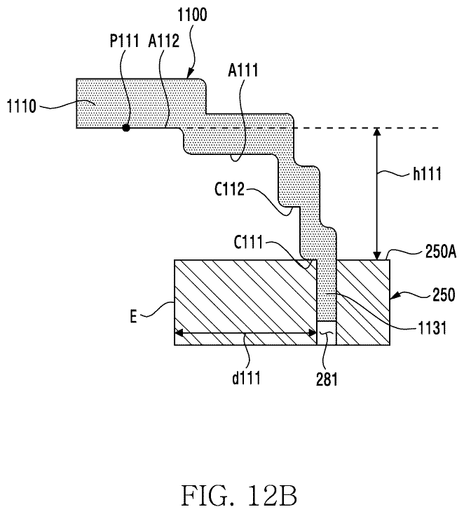

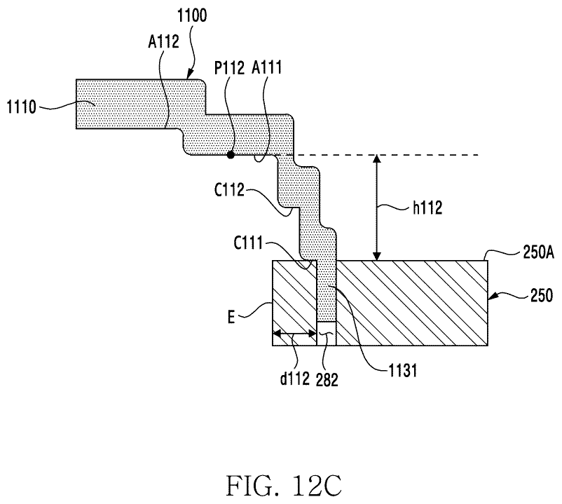

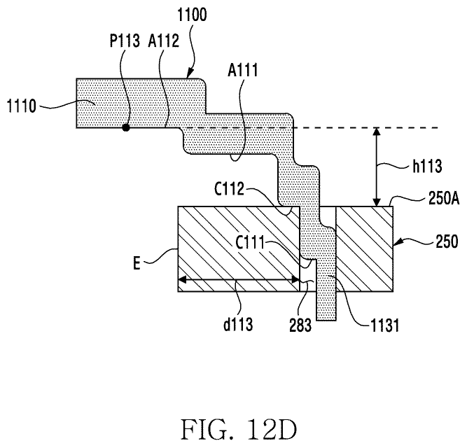

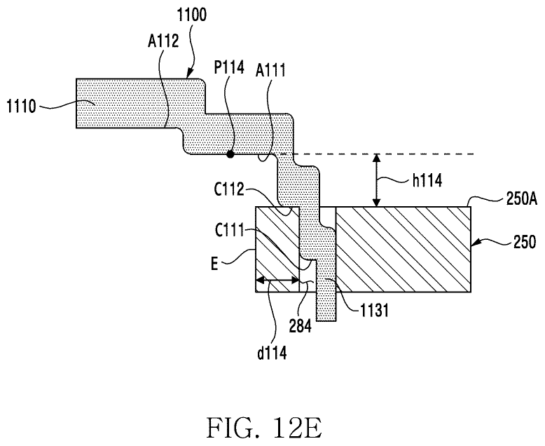

FIG. 12A is a diagram illustrating a connector according to various embodiments. FIGS. 12B, 12C, 12D, and 12E are diagrams illustrating a printed circuit board and a connector coupled in different positions according to various embodiments.

Referring to FIG. 12A, according to an embodiment, a first height a, a second height b, and a third height c may be defined. The first height a may be, for example, a vertical distance between a first flat surface A111 and a second flat surface A112 of a cover portion 1110 of a connector 1100. The second height b may be, for example, a vertical distance between the first flat surface A111 of the cover portion 1110 of the connector 1100 and a second flat surface C112 of a first leg portion 1131. The third height c may be, for example, a vertical distance between a first flat surface C111 and the second flat surface C112 of the first leg portion 1131 of the connector 1100.

The connector 1100 according to an embodiment may be configured to a provide different contact height through a step shape of the cover portion 1110 and a step shape of a leg portion 1130. For example, the contact height provided by the connector 1100 may vary according to a position in which the connector 1100 is coupled (or disposed) to a first printed circuit board 250

For example, referring to FIG. 12B, the connector 1100 may be coupled to the first printed circuit board 250 in a first position. For example, in the first position, the first flat surface C111 of the first leg portion 1131 of the connector 1100 may be supported by contacting a surface 250A of the first printed circuit board 250. For example, in the first position, the first leg portion 1131 of the connector 1100 may be inserted into a first hole 281 of the first printed circuit board 250. A distance between the first hole 281 and an edge E of the first printed circuit board 250 may be a first distance d111.

In an embodiment, in the first position, the connector 1100 may provide a first contact height h111. The first contact height h111 may be, for example, a vertical distance between a point P111 of a second flat surface A112 in contact with the first contact 281 of an electronic component 280 and the surface 250A (or the first flat surface C111 in contact therewith) of the first printed circuit board 250. For example, the first contact height h111 may be the same as a sum of the first height a, the second height b, and the third height c of FIG. 12A.

For example, referring to FIG. 12C, the connector 1100 may be coupled to the first printed circuit board 250 in a second position different from the first position. For example, in the second position, the first flat surface C111 of the first leg portion 1131 of the connector 1100 may be supported by contacting the surface 250A of the first printed circuit board 250. For example, in the second position, the first leg portion 1131 of the connector 1100 may be inserted into a second hole 282 of the first printed circuit board 250. A distance between the second hole 282 and the edge E of the first printed circuit board 250 may be a second distance d112. The second distance d112 in the second position may be smaller than the first distance d111 in the first position. That is, in the second position, the connector 1100 may be disposed closer to the edge E of the first printed circuit board 250 than the connector 1100 of the first position. Accordingly, the connector 1100 of the second position may provide a different contact height from the connector 1100 of the first position.

For example, in the second position, the connector 1100 according to an embodiment may provide a second contact height h112. The second contact height h112 in the second position may be smaller than the first contact height h111 in the first position. The second contact height h112 may be, for example, a vertical distance between a point P112 of the first flat surface A111 in contact with the first contact 281 of the electronic component 280 and the surface 250A (or the first flat surface C111 in contact therewith) of the first printed circuit board 250. For example, the second contact height h112 may be the same as a sum of the second height b and the third height c of FIG. 12A.

For example, referring to FIG. 12D, the connector 1100 may be coupled to the first printed circuit board 250 in a third position different from the first position and the second position. For example, in the third position, the second flat surface C112 of the first leg portion 1131 of the connector 1100 may be supported by contacting the surface 250A of the first printed circuit board 250. For example, in the third position, the first leg portion 1131 of the connector 1100 may be inserted into a third hole 283 of the first printed circuit board 250. A distance between the third hole 283 and the edge E of the first printed circuit board 250 may be a third distance d113. The third distance d113 in the third position may be greater than the second distance d112 in the second position. That is, in the third position, the connector 1100 may be disposed farther from the edge E of the first printed circuit board 250 than the connector 1100 of the second position. In addition, in the third position, the first leg portion 1131 of the connector 1100 may be inserted deeper into the first printed circuit board 250 than the connector 1100 of the first position and the second position. Accordingly, the connector 1100 of the third position may provide a different contact height from the connector 1100 of the first position and the second position.

For example, according to an embodiment, the connector 1100 may provide a third contact height h113 in the third position. The third contact height h113 in the third position may be smaller than the first contact height h111 in the first position and the second contact height h112 in the second position. The third contact height h113 may be, for example, a vertical distance between a point P113 of the first flat surface A111 in contact with the first contact 281 of the electronic component 280 and the surface 250A (or the second flat surface C112 in contact therewith) of the first printed circuit board 250. For example, the third contact height h113 may be the same as a sum of the first height a and the second height b of FIG. 12A.

For example, referring to FIG. 12E, the connector 1100 may be coupled to the first printed circuit board 250 in a fourth position different from the first position, the second position, and the third position. For example, in the fourth position, the second flat surface C112 of the first leg portion 1131 of the connector 1100 may be supported by contacting the surface 250A of the first printed circuit board 250. For example, in the fourth position, the first leg portion 1131 of the connector 1100 may be inserted into a fourth hole 284 of the first printed circuit board 250. A distance between the fourth hole 284 and the edge E of the first printed circuit board 250 may be a fourth distance d114. The fourth distance d114 in the fourth position may be smaller than the third distance d113 in the third position. That is, in the fourth position, the connector 1100 may be disposed closer to the edge E of the first printed circuit board 250 than the connector 1100 of the third position. In addition, in the fourth position, the first leg portion 1131 of the connector 1100 may be inserted deeper into the first printed circuit board 250 than the connector 1100 of the first position and the second position. Accordingly, the connector 1100 of the fourth position may provide a different contact height from the connector 1100 of the first position, the second position, and the third position.

For example, according to an embodiment, the connector 1100 may provide a fourth contact height h114 in the fourth position. The fourth contact height h114 in the fourth position may be less than the first contact height h111 in the first position, the second contact height h112 in the second position, and the third contact height h113 in the third position. The fourth contact height h114 may be, for example, a vertical distance between a point P114 of the second flat surface A112 in contact with the first contact 281 of the electronic component 280 and the surface 250A (or the second flat surface C112 in contact therewith) of the first printed circuit board 250. For example, the third contact height h113 may be the same as the second height b of FIG. 12A.

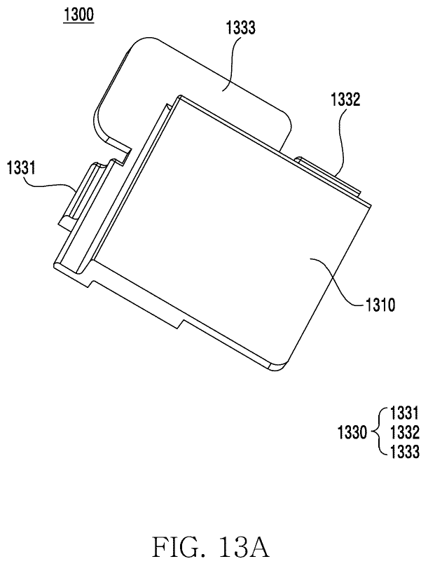

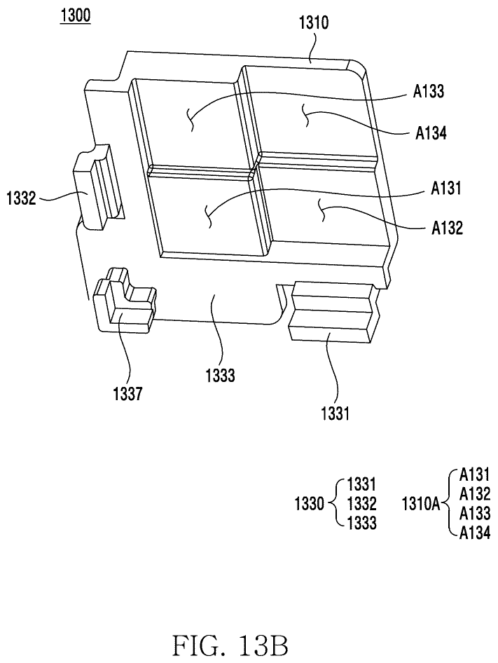

FIGS. 13A and 13B are perspective views illustrating a connector according to various embodiments.

A connector 1300 of FIGS. 13A and 13B may be an example of the above-described connectors 300-1 and 300-2.

Referring to FIGS. 13A and 13B, the connector 1300 of an electronic device 200 according to an embodiment may include a cover portion 1310 and a leg portion 1330 (e.g., the leg portions 330, 730, or 930) extending from the cover portion 1310. The leg portion 1330 may include a first leg portion 1331 (e.g., the first leg portions 331, 731, or 931), a second leg portion 1332 (e.g., the second leg portions 332, 732, or 932), and a third leg portion 1333 (e.g., the third leg portions 333, 733, or 933). In an embodiment, the cover portion 1310 and the leg portion 1330 of the connector 1300 may be formed of a conductive material (e.g., metal). In this regard, the connector 1300 may be referred to as a conductive connector, a conductive member, a conductive piece, a metal picce, a conductive bridge, or a metal bridge.

Referring to FIG. 13B, according to an embodiment, the cover portion 1310 of the connector 1300 may include an inner surface 1310A. The inner surface 1310A of the cover portion 1310 may have a step shape. For example, the step shape of the inner surface 1310A may include a plurality of flat surfaces positioned at different heights. For example, the inner surface 1310A may include a first flat surface A131, a second flat surface A132, a third flat surface A133, and a fourth flat surface A134, which are positioned at different heights. For example, among the plurality of flat surfaces of the inner surface 1310A, the first flat surface A131 may be positioned lowest, and among the plurality of flat surfaces of the inner surface 1310A, the fourth flat surface A134 may be positioned highest. For example, the second flat surface A132 may be located between the third flat surface A133 and the fourth flat surface A134 based on a vertical direction. For example, the third flat surface A133 may be positioned between the first flat surface A131 and the second flat surface A132 based on a vertical direction.

In an embodiment, the first flat surface A131, the second flat surface A132, the third flat surface A133, and the fourth flat surface A134 may be arranged along a quadrant. For example, based on FIG. 13B, the first flat surface A131 may be located at a lower left, the second flat surface A132 may be located at a lower right, the third flat surface A133 may be located at an upper left, and the fourth flat surface A134 may be located at an upper right, respectively, but the disclosure is not limited thereto.

The connector 1300 according to an embodiment may provide a different contact height according to a position coupled to the first printed circuit board 250. For example, the connector 1300 may provide contact heights corresponding to each of the first flat surface A131, the second flat surface A132, the third flat surface A133, and the fourth flat surface A134.

In an embodiment, in case that the first leg portion 1331 and the second leg portion 1332 of the connector 1300 have a step structure, such as first leg portions 731 or 931, the number of types of contact heights provided by the connector 1300 may increase.

According to an embodiment, the connector 1300 may further include a protruding portion 1337 (e.g., protruding portions 1136 or 1137) formed on the third leg portion 1333.

According to an example embodiment, an electronic device may comprise: a printed circuit board, a contact located around the printed circuit board, and a connector disposed on the printed circuit board, and configured to electrically connect the contact and the printed circuit board. The connector may include a leg portion in contact with the printed circuit board and a cover portion extending from the leg portion and in contact with the contact. An inner surface of the cover portion facing a direction of the contact may have a step shape including a first flat surface and a second flat surface parallel to the first flat surface and positioned at a different height from the first flat surface. The contact may be configured to be in contact with the first flat surface from among the first flat surface and the second flat surface of the inner surface of the cover portion.

In an example embodiment, the electronic device may comprise an electronic component including the contact, and a bracket on which the electronic component is seated. The cover portion of the connector may be configured to depress the contact in a direction of the bracket.

In an example embodiment, the electronic component may include a speaker.

In an example embodiment, the first flat surface of the cover portion with which the contact is in contact may be positioned at a first height from the printed circuit board. The second flat surface of the cover portion may be positioned at a second height from the printed circuit board. The first height may be greater than the second height.

In an example embodiment, the first height and the second height may be based on a direction perpendicular to the printed circuit board.

In an example embodiment, when the printed circuit board is viewed from above, the second flat surface of the cover portion of the connector may be located between the first flat surface and the leg portion of the cover portion.

In an example embodiment, the step shape of the inner surface of the cover portion may include a third flat surface. The third flat surface may be parallel to the first flat surface and the second flat surface and may be positioned at a different height from the first flat surface and the second flat surface.

In an example embodiment, the first flat surface of the cover portion, with which the contact is in contact, may be positioned at a first height from the printed circuit board. The second flat surface of the cover portion may be positioned at a second height from the printed circuit board. The first height may be less than the second height.

In an example embodiment, an outer surface of the cover portion opposite to the inner surface, may have a step shape corresponding to the step shape of the inner surface.

In an example embodiment, the cover portion of the connector may include an outer surface opposite to the inner surface. The outer surface of the cover portion may include a flat surface opposite to the first flat surface and the second flat surface of the inner surface. A vertical distance from the first flat surface of the inner surface to the flat surface of the outer surface may be different from a vertical distance from the second flat surface of the inner surface to the flat surface of the outer surface.

In an example embodiment, the leg portion of the connector may include a step structure. The step structure of the leg portion may include a first vertical portion configured to be inserted into a hole of the printed circuit board, a first horizontal portion, and a second horizontal portion positioned at a different height from the first horizontal portion. A surface of the printed circuit board may be configured to support the connector by contacting the first horizontal portion from among the first horizontal portion and the second horizontal portion of the leg portion.

In an example embodiment, the leg portion may include a second vertical portion connecting the first horizontal portion and the second horizontal portion by extending from an edge of the first horizontal portion to an edge of the second horizontal portion. The first vertical portion of the leg portion may extend from another edge of the first horizontal portion in a direction away from the second vertical portion. The second horizontal portion of the leg portion may be positioned higher than the first horizontal portion.

In an example embodiment, the leg portion of the connector may include a second vertical portion connecting the first horizontal portion and the second horizontal portion by extending from an edge of the first horizontal portion to an edge of the second horizontal portion. The first vertical portion of the leg portion may extend from another edge of the second horizontal portion in a direction away from the second vertical portion. The first vertical portion, the second horizontal portion, and the second vertical portion of the leg portion may be located within the hole of the printed circuit board. The first horizontal portion of the leg portion may be positioned higher than the second horizontal portion.

In an example embodiment, the leg portion of the connector may include a third vertical portion. The first vertical portion of the leg portion may extend from a first distal end of the first horizontal portion. The third vertical portion of the leg portion may extend from a second distal end of the first horizontal portion and may be configured to be inserted into another hole of the printed circuit board.

According to an example embodiment, an electronic device may comprise: a printed circuit board, a contact located around the printed circuit board, and a connector, disposed on the printed circuit board, and configured to electrically connect the contact and the printed circuit board. The connector may include a cover portion spaced apart from the printed circuit board and in contact with the contact, and a stepped leg portion extending from the cover portion and configured to be coupled to the printed circuit board. The stepped leg portion of the connector may define a first flat surface, facing a direction of the printed circuit board, and parallel to a surface of the printed circuit board, and a second flat surface, facing the direction of the printed circuit board, parallel to the first flat surface, and positioned at a different height from the first flat surface. The surface of the printed circuit board may be configured to support the connector by contacting the first flat surface from among the first flat surface and the second flat surface of the stepped leg portion.

In an example embodiment, the stepped leg portion of the connector may include a first vertical portion inserted into a hole of the printed circuit board, a first horizontal portion defining the first flat surface, and a second horizontal portion defining the second flat surface.

In an example embodiment, the leg portion may include a second vertical portion connecting the first horizontal portion and the second horizontal portion by extending from an edge of the first horizontal portion to an edge of the second horizontal portion. The first vertical portion of the leg portion may extend from another edge of the first horizontal portion in a direction away from the second vertical portion. The second horizontal portion of the leg portion may be positioned higher than the first horizontal portion.

In an example embodiment, the leg portion of the connector may include a second vertical portion connecting the first horizontal portion and the second horizontal portion by extending from an edge of the first horizontal portion to an edge of the second horizontal portion. The first vertical portion of the leg portion may extend from another edge of the second horizontal portion in a direction away from the second vertical portion. The first vertical portion, the second horizontal portion, and the second vertical portion of the leg portion may be located within the hole of the printed circuit board. The first horizontal portion of the leg portion may be positioned higher than the second horizontal portion.

In an example embodiment, the leg portion of the connector may include a third vertical portion. The first vertical portion of the leg portion may extend from a first distal end of the first horizontal portion. The third vertical portion of the leg portion may extend from a second distal end of the first horizontal portion and is configured to be inserted into another hole of the printed circuit board.

According to an example embodiment, a connector mounted on a printed circuit board may comprise: a leg portion configured to at least partially inserted into the printed circuit board, and a cover portion extending from the leg portion. An inner side of the cover portion may be configured to be in contact with a contact. The inner side of the cover portion may include a step shape such that the connector provides a different height of an area of the cover portion with which the contact is in contact according to a position at which the connector is coupled to the printed circuit board.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a printed circuit board;
a contact located around the printed circuit board; and
a connector, disposed on the printed circuit board, and configured to electrically connect the contact and the printed circuit board, and wherein:
the connector includes a leg portion in contact with the printed circuit board and a cover portion extending from the leg portion and in contact with the contact;
an inner surface of the cover portion facing a direction of the contact has a step shape including a first flat surface and a second flat surface parallel to the first flat surface and positioned at a different height from the first flat surface; and
the first flat surface from among the first flat surface and the second flat surface of the inner surface of the cover portion is configured to contact the contact.

2. The electronic device of claim 1, comprising:
an electronic component including the contact; and
a bracket on which the electronic component is seated, and
wherein the cover portion of the connector is configured to depress the contact in a direction of the bracket.

3. The electronic device of claim 2,
wherein the electronic component includes a speaker.

4. The electronic device of claim 1, wherein:
the first flat surface of the cover portion configured to be in contact with the contact is positioned at a first height from the printed circuit board;
the second flat surface of the cover portion is positioned at a second height from the printed circuit board; and
the first height is greater than the second height.

5. The electronic device of claim 4,
wherein the first height and the second height are based on a direction perpendicular to the printed circuit board.

6. The electronic device of claim 4,
wherein, when the printed circuit board is viewed from above, the second flat surface of the cover portion of the connector is located between the first flat surface and the leg portion of the cover portion.

7. The electronic device of claim 6, wherein:
the step shape of the inner surface of the cover portion includes a third flat surface; and
the third flat surface is parallel to the first flat surface and the second flat surface and is positioned at a different height from the first flat surface and the second flat surface.

8. The electronic device of claim 1, wherein:
the first flat surface of the cover portion, with which the contact is in contact, is positioned at a first height from the printed circuit board;
the second flat surface of the cover portion is positioned at a second height from the printed circuit board; and
the first height is less than the second height.

9. The electronic device of claim 1, wherein:
an outer surface of the cover portion opposite to the inner surface has a step shape corresponding to the step shape of the inner surface.

10. The electronic device of claim 1, wherein:
the cover portion of the connector includes an outer surface opposite to the inner surface;
the outer surface of the cover portion includes a flat surface opposite to the first flat surface and the second flat surface of the inner surface; and
a vertical distance from the first flat surface of the inner surface to the flat surface of the outer surface is different from a vertical distance from the second flat surface of the inner surface to the flat surface of the outer surface.

11. The electronic device of claim 1, wherein:
the leg portion of the connector includes a step structure;
the step structure of the leg portion includes:
a first vertical portion configured to be inserted into a hole of the printed circuit board;
a first horizontal portion; and
a second horizontal portion positioned at a different height from the first horizontal portion; and
a surface of the printed circuit board is configured to support the connector by contacting the first horizontal portion from among the first horizontal portion and the second horizontal portion of the leg portion.

12. The electronic device of claim 11, wherein:
the leg portion includes a second vertical portion extending from an edge of the first horizontal portion to an edge of the second horizontal portion to connect the first horizontal portion and the second horizontal portion;
the first vertical portion of the leg portion extends from another edge of the first horizontal portion in a direction away from the second vertical portion; and
the second horizontal portion of the leg portion is positioned higher than the first horizontal portion.

13. The electronic device of claim 11,
the leg portion of the connector includes a second vertical portion extending from an edge of the first horizontal portion to an edge of the second horizontal portion to connect the first horizontal portion and the second horizontal portion;
the first vertical portion of the leg portion extends from another edge of the second horizontal portion in a direction away from the second vertical portion;
the first vertical portion, the second horizontal portion, and the second vertical portion of the leg portion are located within the hole of the printed circuit board; and
the first horizontal portion of the leg portion is positioned higher than the second horizontal portion.

14. The electronic device of claim 12, wherein:
the leg portion of the connector includes a third vertical portion;
the first vertical portion of the leg portion extends from a first distal end of the first horizontal portion; and
the third vertical portion of the leg portion extends from a second distal end of the first horizontal portion and is configured to be inserted into another hole of the printed circuit board.

15. An electronic device comprising:
a printed circuit board;
a contact located around the printed circuit board; and
a connector disposed on the printed circuit board and configured to electrically connect the contact and the printed circuit board, and wherein:
the connector includes:
a cover portion spaced apart from the printed circuit board and in contact with the contact; and
a stepped leg portion extending from the cover portion and coupled to the printed circuit board;
the stepped leg portion of the connector defines:
a first flat surface, facing a direction of the printed circuit board, and parallel to a surface of the printed circuit board; and
a second flat surface, facing the direction of the printed circuit board, parallel to the first flat surface, and positioned at a different height from the first flat surface; and
the surface of the printed circuit board is configured to support the connector by contacting the first flat surface from among the first flat surface and the second flat surface of the stepped leg portion.

16. The electronic device of claim 15,
wherein the stepped leg portion of the connector includes:
a first vertical portion configured to be inserted into a hole of the printed circuit board;
a first horizontal portion defining the first flat surface; and
a second horizontal portion defining the second flat surface.

17. The electronic device of claim 16, wherein:
the leg portion includes a second vertical portion extending from an edge of the first horizontal portion to an edge of the second horizontal portion to connect the first horizontal portion and the second horizontal portion;
the first vertical portion of the leg portion extends from another edge of the first horizontal portion in a direction away from the second vertical portion; and
the second horizontal portion of the leg portion is positioned higher than the first horizontal portion.

18. The electronic device of claim 16, wherein:
the leg portion of the connector includes a second vertical portion extending from an edge of the first horizontal portion to an edge of the second horizontal portion to connect the first horizontal portion and the second horizontal portion;
the first vertical portion of the leg portion extends from another edge of the second horizontal portion in a direction away from the second vertical portion;
the first vertical portion, the second horizontal portion, and the second vertical portion of the leg portion a located within the hole of the printed circuit board; and
the first horizontal portion of the leg portion is positioned higher than the second horizontal portion.

19. The electronic device of claim 17, wherein:
the leg portion of the connector includes a third vertical portion;
the first vertical portion of the leg portion extends from a first distal end of the first horizontal portion; and
the third vertical portion of the leg portion extends from a second distal end of the first horizontal portion and is configured to be inserted into another hole of the printed circuit board.

20. A connector configured to be mounted on a printed circuit board comprising:
a leg portion configured to at least partially inserted into the printed circuit board; and
a cover portion extending from the leg portion, and wherein:
an inner side of the cover portion is configured to be in contact with a contact; and
the inner side of the cover portion includes a step shape such that the connector provides a different height of an area of the cover portion with which the contact is in contact based on a position at which the connector is coupled to the printed circuit board.
